(19) United States
(12) Patent Application Publication
(10) Pub. No.: US 2011/0045351 A1
(43) Pub. Date: Feb. 24, 2011

(54) High-Power Nanoscale Cathodes for Thin-Film Microbatteries

(75) Inventors: Emanuel Peled, Even Yehuda (IL); Diana Golodnitsky, Rishon Letzion (IL); Hadar Mazor-Shafir, Herzeliya (IL); Kathrin Freedman, Kfar Yona (IL); Tania Ripenbein, Netanya (IL)

Correspondence Address: D. Kligler I.P. Services LTD, P.O. Box 25, Zippori, 17910, IL

(73) Assignee: RAMOT AT TEL-AVIV UNIVERSITY LTD., Tel Aviv (IL)

(21) Appl. No.: 12/859,297

(22) Filed: Aug. 19, 2010

Related U.S. Application Data
(60) Provisional application No. 61/236,094, filed on Aug. 23, 2009.

(51) Int. Cl. H01M 4/52; H01M 4/56; H01M 4/58; C25D 3/20; C25D 3/12; C25D 3/38; C25D 3/54; C25D 5/02

(52) U.S. Cl. 429/220; 429/231.5; 429/223; 429/221; 429/224; 205/270; 205/271; 205/261; 205/296; 205/262; 205/122

(57) ABSTRACT

A method, including placing a substrate of a battery in a bath consisting of a metal M chosen from a metal group consisting of Fe, Ni, Co, Cu, W, V, and Mn, an oxidant selected from an oxidant group consisting of oxygen and sulfur, and a polymer. The method also includes applying an electrical current so as to form on the substrate a metal M compound cathode having a nanoscale grain structure.

### CROSS-REFERENCE TO RELATED APPLICATION

This application claims the benefit of U.S. Provisional Patent Application 61/236,094, filed 23 Aug. 2009, which is incorporated herein by reference.

### FIELD OF THE INVENTION

The present invention relates generally to batteries, and specifically to electrode formation of the batteries.

### BACKGROUND OF THE INVENTION

Intricate wireless sensor networks (WSN) that enable increasing communication, information exchange, location awareness and advanced medical capabilities are expected to change our day-to-day life remarkably. WSN applications include anti-terrorism microchip sensors for the detection of toxic materials, seismic transducers for oil exploration, unmanned air microvehicles, fully integrated RF (radiofrequency) multi-functional identification cards, and non-volatile memory. Microsensors are widely used in advanced surgery and diagnostics for sophisticated operation tools and gastrointestinal-imaging devices.

However, it is clear that the overall goals of many WSN applications have not and will not be met unless appropriate power sources are developed. It has long been recognized that micro-systems need similar-sized power sources. Miniaturization of conventional “bulk” batteries is unsatisfactory for most microsystem requirements. The use of typical two-dimensional thin-film structures requires relatively large footprints of at least a few cm² in order to provide reasonable capacity and energy; this renders them irrelevant for microsystem applications.

The description above is presented as a general overview of related art in this field and should not be construed as an admission that any of the information it contains constitutes prior art against the present patent application.

### SUMMARY OF THE INVENTION

There is provided, according to an embodiment of the present invention, a method, including:

placing a substrate of a battery in a bath including a metal M chosen from a metal group consisting of Fe, Ni, Co, Cu, W, V, and Mn, an oxidant selected from an oxidant group consisting of oxygen and sulfur, and a polymer; and

applying an electrical current so as to form on the substrate a metal M compound cathode having a nanoscale grain structure.

Typically, the metal M includes copper, the oxidant includes sulfur, and the compound includes copper sulfide. In one embodiment the substrate has multiple channels therein, and the copper sulfide cathode is deposited on an inner surface of the channels. In some embodiments the multiple channels include multiple through channels perforating the substrate. The copper may be formed as ethylenediaminetetraacetic acid-disodium-copper (CuNa₂EDTA). Typically, forming the copper sulfide cathode on the substrate includes forming a metallic current collector on the substrate and depositing the copper sulfide cathode on the current collector.

Typically, the polymer is selected from a group of polymers consisting of polyethyleneimine (PEI), polyethylene glycol dimethyl ether (PEGDME), and polyethylene oxide. In some embodiments a molecular weight of the PEGDME is selected from a group of weights consisting of 500 and 2000.

In a disclosed embodiment the metal M includes vanadium, the oxidant includes oxygen, and the compound comprises a vanadium oxide. Typically, the polymer includes polyaniline (PANI), the vanadium may be formed as one of a group of salts comprising NH₄VO₃ and VOSO₄, and the vanadium oxide consists of vanadium pentoxide (V₂O₅).

In a further disclosed embodiment the oxidant consists of oxygen and sulfur, and the compound includes a metal oxysulfide. The metal M may include Fe, and the bath may include FeCl₃ with Na₂S₂O₃. The ratio of FeCl₃ to polymer may be 1:5. Typically, the metal oxysulfide has a formula MOₓS_{y}, wherein 0<x<3, 0<y<3.

In an alternative embodiment the metal M may be selected from an element E chosen from a group of elements consisting of Fe, Ni, Co, W, V, and Mn;

the oxidant includes sulfur; and

the compound includes a sulfide of the element E.

There is further provided, according to an embodiment of the present invention, a rechargeable microbattery including a copper sulfide cathode having a nanoscale grain structure.

There is further provided, according to an embodiment of the present invention, a rechargeable microbattery including a vanadium oxide cathode having a nanoscale grain structure.

There is further provided, according to an embodiment of the present invention, a rechargeable microbattery comprising a metal oxysulfide MOₓS_{y} cathode having a nanoscale grain structure, wherein a metal M of the metal oxysulfide is selected from a group of metals consisting of Fe, Ni, Co, Cu, W, V, and Mn, and wherein 0<x<3, 0<y<3.

There is further provided, according to an embodiment of the present invention, a method, including:

placing a substrate of a battery in a bath containing lithium, phosphorus, oxygen, a metal M where M is selected from iron, nickel and cobalt, and a polymer; and

applying an electrical current so as to form on the substrate, by electrophoretic deposition (EPD), a lithium metal phosphate (LiMPO₄) cathode having a nanoscale grain structure.

There is further provided, according to an embodiment of the present invention, a method, including:

placing a substrate of a battery in a bath containing lithium, a metal M where M is selected from manganese and cobalt, oxygen, and a polymer; and

applying an electrical current so as to form on the substrate, by electrophoretic deposition (EPD), a lithium metal oxide cathode having a nanoscale grain structure.

There is further provided, according to an embodiment of the present invention, a battery including:

a substrate; and

a metal-M-compound electrode having a nanoscale grain structure and being formed on the substrate by applying an electrical current in a bath containing a metal M chosen from a metal group consisting of Fe, Ni, Co, Cu, W, V, and Mn, an oxidant selected from an oxidant group consisting of oxygen and sulfur, and a polymer.

The present invention will be more fully understood from the following detailed description of the embodiments thereof, taken together with the drawings in which:

### BRIEF DESCRIPTION OF THE DRAWINGS

FIG. 1 is a pictorial, schematic illustration of a perforated substrate used as a base for constructing a microbattery, according to an embodiment of the present invention;

FIG. 2 is a schematic vertical cross-section of the microbattery, according to an embodiment of the present invention;

FIG. 3 is a schematic flow chart describing the production of a non-perforated battery, according to an embodiment of the present invention;

FIG. 4 is a schematic flow chart describing the production of a perforated battery, according to an embodiment of the present invention;

FIGS. 5A, 5B, and 5C are scanning electron microscope (SEM) images of deposited copper sulfide films formed on planar substrates, according to an embodiment of the present invention;

FIGS. 5D, 5E, and 5F are SEM images of deposited copper sulfide films formed on perforated substrates, according to an embodiment of the present invention

FIG. 6A and FIG. 6B show schematic charge/discharge graphs of planar Li/CuS cells, according to an embodiment of the present invention;

FIG. 7A shows schematic graphs illustrating the polarization properties of Li/CuS cells with unmodified and modified cathodes, according to an embodiment of the present invention;

FIG. 7B shows schematic graphs illustrating the reversible capacity of Li/CuS cells with unmodified and modified cathodes, according to an embodiment of the present invention;

FIG. 8 shows SEM images of vanadium pentoxide, V₂O₅, cathodes, according to an embodiment of the present invention;

FIG. 9 shows SEM images of modified V₂O₅ cathodes, according to an embodiment of the present invention;

FIGS. 10A, 10B, and 10C show schematic exemplary graphs for cells with modified V₂O₅ cathodes, according to an embodiment of the present invention;

FIG. 11A shows SEM images of modified FeOₓS_{y} cathodes, according to an embodiment of the present invention;

FIGS. 11B and 11C schematically show measurements on cells using the modified FeOₓS_{y} cathodes, according to an embodiment of the present invention;

FIGS. 12A and 12B schematically show further measurements on cells using modified FeOₓS_{y} cathodes, according to an embodiment of the present invention;

FIGS. 13A, 13B, and 13C are SEM images of LiFePO₄, according to an embodiment of the present invention;

FIGS. 14A and 14B are schematic graphs of properties of cells with LiFePO₄ cathodes, according to an embodiment of the present invention;

FIGS. 15A and 15B are further schematic graphs of cells with LiFePO₄ cathodes, according to an embodiment of the present invention;

FIG. 16 is an SEM image of a modified LiFePO₄ cathode with nickel incorporated, according to an embodiment of the present invention;

FIGS. 17A and 17B are schematic graphs of cells with a modified LiFePO₄ cathode with nickel incorporated, according to an embodiment of the present invention;

FIG. 18 is a schematic charge/discharge graph of a cell with a modified LiFePO₄ cathode, according to an embodiment of the present invention; and

FIG. 19 is a further schematic charge/discharge graph of a cell with a modified LiFePO₄ cathode, according to an embodiment of the present invention.

### DETAILED DESCRIPTION OF EMBODIMENTS

### Overview

Embodiments of the present invention provide methods for forming a cathode of a rechargeable cell. The cell typically comprises rechargeable three-dimensional concentric microbatteries (3DCMBs) formed in a perforated substrate. The cathode is formed on inner surfaces of perforating channels of the substrate, as well as on the outer surfaces of the substrate. An anode, typically comprising lithiated graphite, lithium metal, or lithium alloy, is also formed in the perforating channels and on the outer surfaces of the substrate. Alternatively, in semi-3DCMBs, the cathode may be formed in the channels and on the outer surfaces of the substrate, but the anode is only formed on the outer surfaces. Further alternatively, the cell may be formed as a substantially two-dimensional structure, comprising an anode and cathode that are planar.

In one embodiment the cathode comprises copper sulfide. The morphology and composition of the copper sulfide is modified from its pristine state by forming the copper sulfide by electro-deposition from a bath containing a polymer. The modified copper sulfide has a “nanoscale” grain structure, i.e., the sizes of grains of the deposited copper sulfide are in the nanometer range.

In an alternative embodiment the cathode comprises a vanadium oxide, typically vanadium pentoxide, modified as described above by being formed using electro-deposition from a bath containing a polymer. The modified vanadium oxide also has a nanoscale grain structure.

In further alternative embodiments, the cathode comprises a metal sulfide other than copper sulfide, an oxide other than vanadium oxide, or a metal oxysulfide. All of these cathodes are modified by being formed by electro-deposition from a bath containing a polymer, and all have nanoscale grain structures.

The inventors have found that the modified cathodes, produced as described herein, form cells having superior characteristics, such as higher capacity and improved cyclability, compared to cells with pristine, unmodified, cathodes.

In some embodiments the modified cathodes comprise compounds formed of a metal and an oxidant, typically oxygen and/or sulfur, so that the cathodes typically comprise a sulfide, an oxysulfide, or an oxide.

In the disclosure and in the claims, reference to an elemental entity is to be understood as comprising reference to derivatives of the entity. For example, the term oxygen comprises ionic oxygen, and oxygen which is part of a compound, such as an oxide or a sulfate.

### DETAILED DESCRIPTION

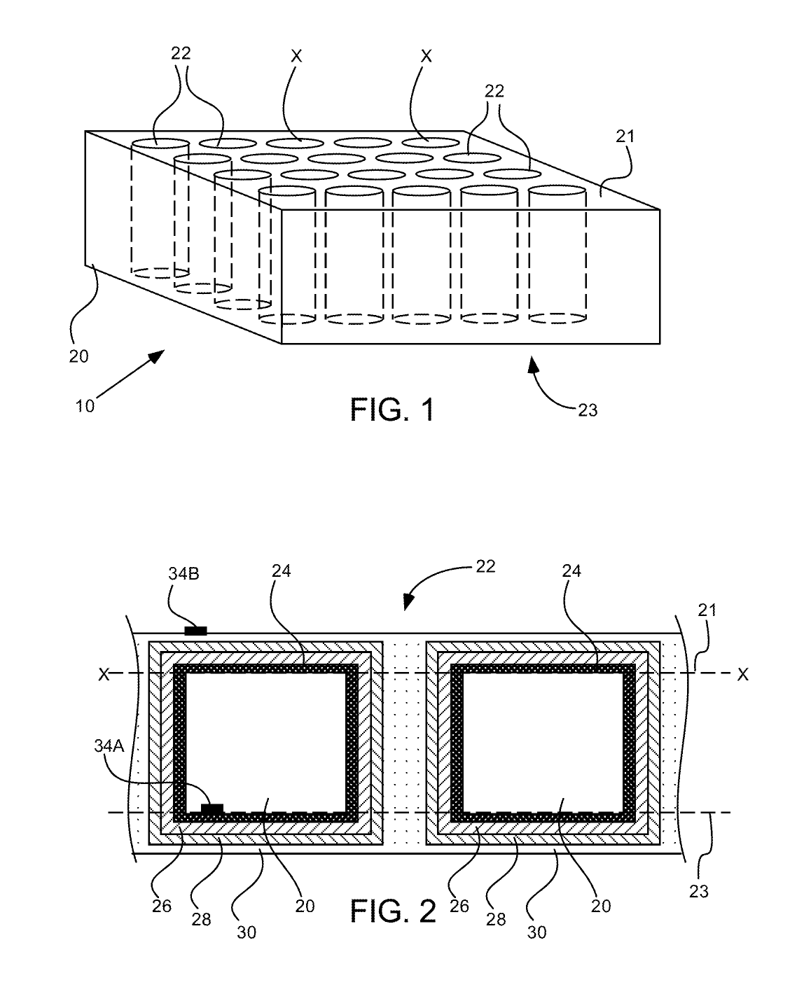

Reference is now made to FIG. 1, which is a pictorial, schematic illustration of a perforated substrate 20 used as a base for constructing a rechargeable microbattery 10, according to an embodiment of the present invention. In the exemplary embodiment of FIG. 1, substrate 20 comprises a planar structure having two opposite faces 21, 23, although substrates having other shapes and forms, such as curved substrates, can also be used. Multiple through channels 22 perforate substrate 20, penetrating the entire thickness of the substrate from one face to the other.

In some embodiments, substrate 20 comprises a wafer or other plate in which channels 22 are formed using a suitable electrochemical etching or lithography process. Exemplary methods for producing channels are described in PCT Patent Application PCT/IL2005/000414, which is assigned to the assignee of the present patent application, and which is incorporated herein by reference. The substrate material may comprise a semiconductor such as silicon, a plastic, a metal, an alloy, carbon, a composite material or any other suitable material.

Alternatively, substrate 20 may comprise a microchannel plate (MCP) structure, i.e., a two-dimensional array of small diameter tubes, which are fused together and sliced to form a thin plate. Methods for producing MCPs are described, for example, in U.S. Pat. Nos. 6,300,709, 6,260,388 and 6,270,714, whose disclosures are incorporated herein by reference. Some aspects of producing microbatteries using MCPs are described in PCT Patent Application PCT/IL2004/000945, which is assigned to the assignee of the present patent application, and which is incorporated herein by reference.

The thickness of substrate 20 (and thus the height of channels 22) is typically in the range of 100-800 microns, although the methods described herein can be used to fabricate microbatteries in substrates of any thickness. The characteristic width or diameter of the channels is typically on the order of several tens of microns. The channels are separated by substrate walls having a thickness that may typically vary from 1 micron up to several tens of microns. The total number of channels in 1 cm² of a typical microbattery can vary from several hundreds to several tens of thousands, depending on the channel diameter, the wall thickness and the electrical specifications of the battery. The channels normally have an aspect ratio (i.e., a height-to-width ratio) greater than one, and the aspect ratio is typically high, i.e., their height is significantly larger than their diameter. Although the examples herein show cylindrical channels having round cross-sections, other shapes and cross-sections can also be used. In some embodiments, the channels may not necessarily comprise through channels. In other words, rather than the channels completely piercing the substrate by penetrating the substrate's upper and lower surfaces, the channels may only partly pierce the substrate by penetrating only one of the surfaces of the substrate.

FIG. 2 is a schematic vertical cross-section of microbattery 10, according to an embodiment of the present invention. The vertical cross-section is taken to include a line X-X in surface 21 in FIG. 1. A current collector layer 24 is formed over the surface area of substrate 20. Layer 24 comprises a metallic layer such as nickel or gold, which is deposited over substrate 20 using any suitable thin-film deposition process known in the art, such as that described further below. Layer 24 forms a structure that coats the entire surface area of the perforated substrate. In particular, layer 24 coats the interior surfaces of channels 22. Exemplary microbatteries in which layer 24 comprises a 2-4 micron nickel or gold layer are described below. Alternatively, thinner (e.g., 1 micron) or thicker current collector layers can also be used.

Current collector layer 24 forms one of the terminals of the microbattery. In alternative embodiments, for example when substrate 20 comprises an electrically-conductive material, current collector 24 can be omitted. In some cases, a carbon, a semiconducting, or a metallic substrate may be sufficiently conductive so as to obviate the use of layer 24. For example, a perforated metal sheet, a carbon (e.g., graphite) mesh or a highly doped silicon wafer may serve as an electrically-conductive substrate.

A cathode layer 26 is formed over the current collector layer (or directly over the perforated substrate, if the current collector layer is omitted). Layer 26 substantially coats the entire surface area of the current collector, both internally and externally to channels 22. When current collector layer 24 is omitted, the cathode layer coats the substrate, and the substrate itself forms one of the terminals of microbattery 10.

The composition of cathode layer 26, and its method of formation, are described below.

The thickness of cathode layer 26 used in the microbattery configurations described herein may vary from approximately 20 nm to over 10 microns. A thicker cathode typically increases the energy density of the battery.

An electrolyte separator layer is applied over cathode layer 26 to form the separator layer of the microbattery. In the examples described below, the separator layer comprises a hybrid polymer electrolyte (HPE) membrane 28. Alternatively, membrane 28 may comprise a ceramic or other solid electrolyte, a polymer electrolyte or a gel electrolyte. Typically, membrane 28 is ion-conducting. The membrane material can be inserted into the channels using any suitable process known in the art, such as spin-coating, vacuum-assisted pulling, pasting, pressure-filling and casting processes.

An anode layer 30 is formed on or otherwise attached to the outer surface or surfaces of the ion-conducting membrane. In the examples described below, anode layer 30 comprises graphite. Alternatively, the anode may comprise any other suitable material, such as various lithium alloys known to reversibly intercalate with lithium and comprising one or more elements selected from: Si, Sn, Sb, Al, Mg, Cu, Ni and Co. The anode may alternatively comprise any other suitable alkali metal or alkali metal alloy.

The anode may be deposited onto the outer surface of membrane 28 using a thin- or thick-film deposition process. Alternatively, the anode may comprise a thin foil made of anode material and attached to the surface of the membrane.

Two terminals of the microbattery, denoted 34A and 34B, are connected to the current collector layer and the anode layer respectively. Terminal 34A is led through a suitable opening in the microbattery structure and connected to current collector layer 24. Terminal 34B is connected directly to anode layer 30. Optionally, a second current collector (not shown) may be overlaid on anode layer 30, in which case terminal 34B is connected to the second current collector.

Microbatteries having a perforated structure such as that exemplified by microbattery 10 are also herein termed three-dimensional concentric microbatteries (3DCMBs). For each channel of a 3DCMB there is central material which is part of the anode structure. Microbatteries having a perforated structure, but wherein the channels do not have central material as part of the anode, are termed semi-3DCMBs. Semi-3DCMBs have a planar anode and a cathode that is formed in the perforating channels. The electrode films described herein may be applied to 3DCMBs and to semi-3DCMBs. The films may also be applied to batteries having a structure which is different from that of these microbatteries, for example, to batteries which do not have the perforated structure of 3DCMBs or semi-3DCMBs, and which typically have structures comprising a number of parallel, generally planar, sheets. Such batteries are referred to herein as non-perforated or planar batteries.

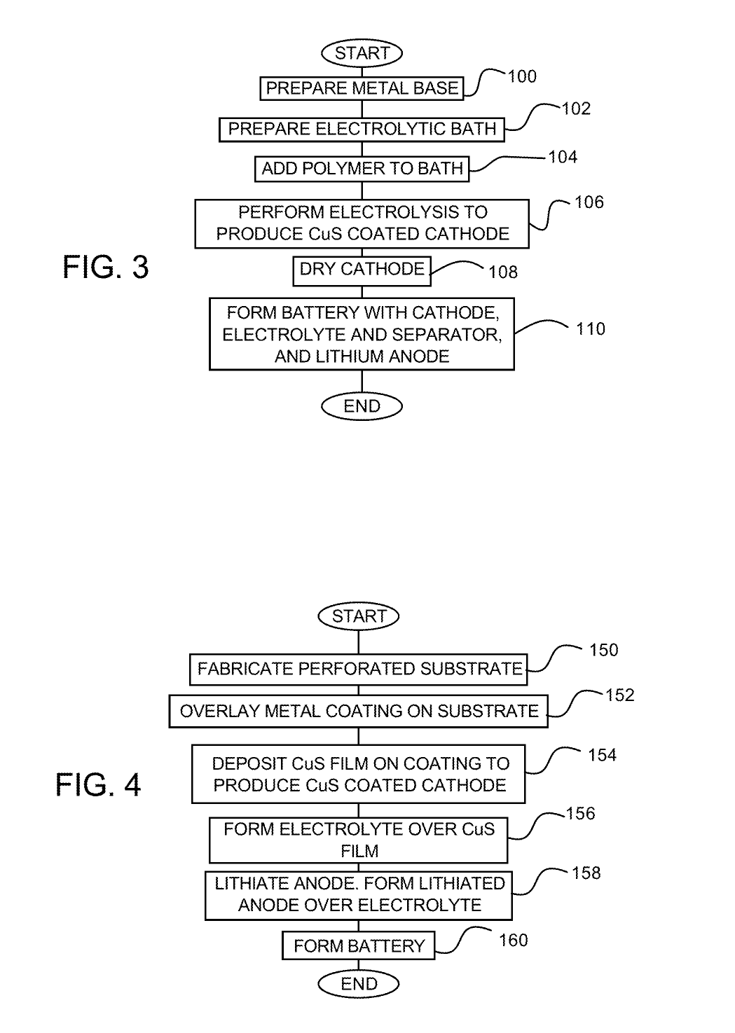

FIG. 3 is a schematic flow chart describing the production of a non-perforated battery, according to an embodiment of the present invention. In a first step 100, a metal base is prepared. The metal of the base is typically nickel or gold, and the base may typically be a nickel film or a nickel-coated or a gold-coated silicon substrate. Hereinbelow the base is assumed to comprise a gold-coated silicon substrate.

In a bath preparation step 102, an electrolytic bath for generating a copper sulfide cathode film is prepared. In the description and in the claims, the term copper sulfide is assumed to comprise any material that has a composition that can be represented by CuₓS_{y}, where

$$\frac{y}{x} > 0.7 .$$

In one embodiment the bath consists of 1,2-propanediol (propylene glycol), ethylenediaminetetraacetic acid-disodium-copper (CuNa₂EDTA) and the oxidant elemental sulfur. Ammonium chloride (NH₄Cl) and ammonium hydroxide (NH₄OH) are added for high ionic strength and as buffer additives.

In a polymer step 104, the electrolyte bath is modified by the addition of a polymer, such as polyethyleneimine (PEI) or polyethylene glycol dimethyl ether (PEGDME) typically having a molecular weight of 500 or 2000, or polyethylene oxide (PEO). Alternatively, other polymer materials may be used. The polymers are typically prepared as solutions of analytical-grade chemicals dissolved in propylene glycol, and any molecular weight polymer that is compatible with a propylene glycol based solution may be used.

The range of polymer concentration depends on the concentration of copper and sulfur in the solution. In disclosed embodiments the inventors have used CU:PEG weight ratios varying from 1:1 to 1:6. The inventors have found that the concentrations of sulfur and CuNa₂EDTA may vary from approximately 0.01M to approximately 1M.

In an electrolysis step 106, electrolysis is performed in an electrolytic deposition bath housing, by setting the gold- or nickel-coated silicon substrate as a cathode (working electrode) and two platinum grids as counter electrodes. The electrolysis cell compartment contains silicon substrate placed between the two platinum grids. The bath temperature is maintained at approximately 60-85° C., the deposition current density is allowed to vary between approximately 1 and approximately 10 mA/cm², and the pH is maintained in the approximate range 6-9. In one embodiment a Princeton Applied Research potentiostat/galvanostat, model 263A, (produced by Princeton Applied Research, Oak Ridge, Tenn.) interfaced with appropriate power-suite software and a personal computer was used to control the electro-deposition process and to monitor the current and voltage profiles, but any other suitable means for controlling the electro-deposition process may be used.

The electrolysis step deposits copper sulfide on the nickel- or gold-coated substrate, forming a thin film of the copper sulfide on the current collector. The resulting copper sulfide-coated composite sample is used as a cathode in a lithium/CuS battery.

In a drying and handling step 108, the copper sulfide coated sample is dried under vacuum at 100° C. for hours and subsequent handling is in a dry argon atmosphere having less than 10 ppm water.

In a battery production step 110 a planar electrochemical coin cell is produced conforming to International standard IEC 60086-3 size 2032, i.e., having a diameter of 20 mm and a height of 3.2 mm.

The cell comprises a lithium metal sheet, typically having an area of approximately 0.6 cm², as an anode. An electrolyte layer is formed as a 1M solution of LiPF₆ in a 1:1 mixture of ethylene carbonate (EC) and diethyl carbonate (DEC), with addition of 2% (v/v) vinylene carbonate (VC). A separator, product number 2400, produced by Celgard LLC of Charlotte, N.C. is used. A cathode is formed from the dried copper sulfide coated sample produced in step 108.

FIG. 4 is a schematic flow chart describing the production of a perforated battery, according to an embodiment of the present invention. In a first step 150, a perforated substrate, substantially similar to substrate 20 (FIG. 1) is fabricated.

In one embodiment, the perforated substrate is formed from a 300 μm thick silicon crystalline wafer which is etched with circular channels having a 50 μm diameter and a 30 μm spacing between the channels. Typically the channels are formed on a rectangular grid, although other grids, such as a hexagonal grid, are possible. The channels may be formed by an inductively coupled plasma etching process, or by any other convenient process, such as anisotropic electrochemical etching.

A substrate formed with the dimensions described, and with the channels on a rectangular grid, has an area gain, i.e., the ratio of the area generated to the area of an un-perforated wafer, of approximately 9. Such a perforated substrate has approximately 10,000 channels for each cm² of crystalline wafer.

Typically, the perforated sheet has the following dimensions:

t≦500 μm;d=50 μm;s≦10 μm

where
t is the sheet thickness;
d is the diameter of the perforating channels; and
s is the spacing between the channels.

A perforated sheet having t=500 μm, d=50 μm, and s=10 μm, with its channels formed on a rectangular grid, has an area gain of approximately 23.

In a base preparation step 152, a conformal metal coating, which is to act as a cathode current collector in the completed battery, is overlaid on the perforated sheet. The coating may be applied using an electroless or auto-catalytic plating method, or a chemical vapor deposition process, or any other suitable process. The metal is typically nickel or gold, and the coating thickness is typically in the approximate range of 2 μm-4 μm.

After the metal coating has been formed in step 152, in a copper sulfide deposition step 154 a thin film of copper sulfide is deposited on the coating. The process of deposition is substantially as described in steps 102, 104, 106, and 108 of the flow chart of FIG. 3, comprising preparing an electrolytic bath. The bath is modified by adding polymer, and electrolysis is performed in the bath to deposit a copper sulfide film on the metal coating. The copper sulfide film is then dried in vacuum at 100° C. to produce the copper sulfide coated cathode.

In an electrolyte provision step 156, an electrolyte is formed over the copper sulfide film. The electrolyte is typically formed as an HPE membrane, for example a composite of poly(vinylidene fluoride) (PVdF) on a SiO₂ network. In one embodiment the membrane is soaked in a solution of a lithium salt, for example, 1M LiBF₄ in a 1:9 EC:DEC solvent, or 1M LiPF₆ in a 1:1 EC:DEC solvent.

In an anode production step 158, a thin lithium film is intimately attached to a graphite surface by being gently pressed to the surface. The lithiation of the graphite is typically carried out under open circuit voltage (OCV) conditions for a preset length of time, typically approximately 10 h. The lithiated graphite is applied to the polymer electrolyte membrane, for use as an anode.

In a final step 160, the components described above are incorporated into an electrochemical coin cell conforming to International standard IEC 60086-3 size 2032.

It will be understood that the flow charts of FIGS. 3 and 4 describe exemplary processes for producing particular types of batteries, and those having ordinary skill in the art will be able to adapt the flow charts, mutatis mutandis, for producing other types of batteries.

The flow charts of FIGS. 3 and 4 describe production of copper sulfide cathodes, wherein the electrolytic bath producing the cathodes is modified by having a polymer added to the bath. As is described in more detail below, cathodes produced by this process, i.e., by having polymer added to the electrolytic bath, have a characteristic structure comprising grains having sizes in the nanometer range. In the description and in the claims, the term “nanoscale” is used to refer to materials having this type of structure, i.e., having grain sizes in the nanometer range.

Also in the description and in the claims, cathodes produced using a polymer in the electrolytic bath, as described in the flow charts of FIG. 3 and FIG. 4, are termed modified cathodes. Cathodes produced without a polymer in the bath are termed pristine or unmodified cathodes.

Copper sulfide has a good electrical conductivity of approximately 10⁻³ S/cm and a high theoretical specific energy capacity of approximately 560 mAh/g. Using an unmodified copper sulfide cathode as the cathode of a battery provides the battery with a flat discharge curve. The inventors considered these properties in choosing copper sulfide to form a modified cathode.

The following examples illustrate several possible 3D microbattery implementations having CuS cathodes that use methods disclosed herein.

### Example 1

A semi-3DCMB was assembled, generally as described, mutatis mutandis, by the flow chart of FIG. 4 and as schematically illustrated in FIGS. 1 and 2. The cell consisted of a CuS cathode, a hybrid polymer electrolyte and a lithium anode. All the layers except the anode were inserted inside the channels.

The substrate used was a perforated silicon chip. A silicon substrate containing arrays of through-holes was prepared with the use of photolithography and double-sided Deep Reactive-Ion Etching (DRIE). The (100) substrate was a double-side polished, 440 μm-thick, three-inch silicon wafer. The wafer was coated with about 10 μm of AZ-4562 photoresist, and arrays of square holes with a side dimension of 40 μm and inter-hole spacing of about 10 μm were defined.

As a first step in the formation of the microbattery, i.e., the conformal deposition of the battery layers, the substrate was treated to enhance the adhesion of a nickel or gold current collector. The treatment included sequential soaking and degreasing in a detergent solution and ethanol, in an ultrasonic bath at room temperature. This was followed by immersion of Si in boiling cyclohexane and concentrated (98%) sulfuric acid. The thoroughly degreased surface was etched in a 1:4 mixture of hydrofluoric (40%) and sulfuric (98%) acids. Prior to being coated with nickel or gold, the substrates were subjected to sensitization and activation procedures. Sensitization was carried out in a solution containing 20-50 g L-1 SnCl₂H₂O; 40-50 mL L-1 HCl (32%). The activation bath contained 0.5-1.5 g L-1 PdCl₂; 1.5-10 mL L-1 HCl (32%). To ensure homogeneous coating of silicon by a thin palladium layer, HF (40%) was added to the sensitization solution.

An electroless method was used to deposit the nickel on all available surfaces of the perforated silicon substrate. Activated samples were immersed in an alkaline Ni-electroless bath with trisodium citrate as a complexant and sodium hypophosphite as a reduction component. The autocatalytic process was carried out at 65-70° C. for a few minutes (5-15 min). The thickness of the deposited samples varies with the time of deposition, for example 15 min of deposition gave approximately 2 micron thick coating. The composition of the electroless solution is as follows: nickel sulfamate-0.100M, sodium citrate-0.125M, sodium acetate-0.100M, sodium hypophosphite-0.314M, thiourea-0.1 mg/L, sodium dodecylsulfate-10 mg/L, pH-9. We obtained conformal and highly adherent deposits of the nickel current collector with complete coverage of the microchannels. After thorough washing with deionized water, the Ni-plated Si was subjected to electrochemical cathode deposition.

Electrodeposition of thin CuS films was carried out generally as described for step 154 above. The concentrations of propylene glycol, ammonium chloride, and ammonium hydroxide, were 20 mM, 30 mM, and 45 mM respectively.

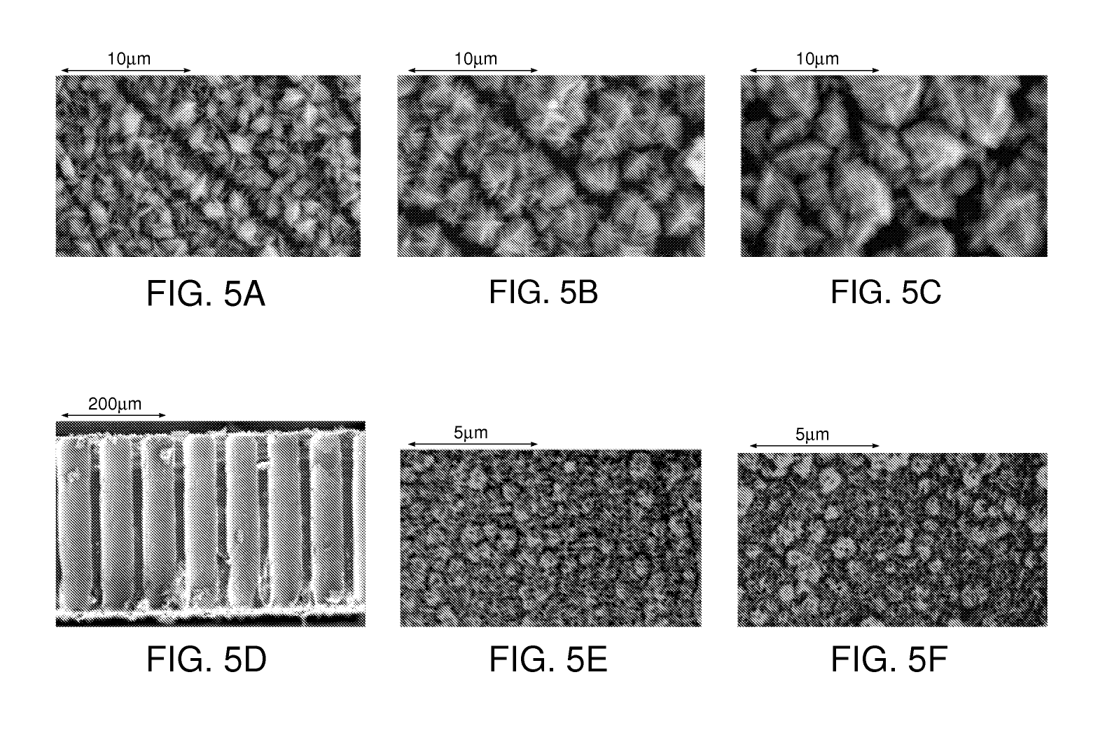

A special flow system was constructed in order to ensure conformal deposition inside the high aspect ratio channels. The Au-coated perforated sample was placed between two Pt grids acting as counter electrodes. The cell was connected to the reservoir of electrolytic bath via a peristaltic pump that provided a constant flow rate of 0.3 L/min. A thin film copper sulfide layer was obtained from the electro-reduction of ethylene diamine complexes and sulfide anion (S2-) by applying a negative constant current to the Au-coated Si. The inventors have also found that similar results are obtained using constant potential deposition; in addition, similar results may also be obtained using a variable current or potential. The cathodic electrodeposition was carried out for 45 minutes at a constant current of 2.5 mA/cm². The pH of the electrolytic bath was 8-9 and temperature was about 85° C. PEGDME 500 at 6:1 polymer to salt ratio has been added to the solution in order to improve adhesion of the deposit by reducing the internal stresses, which develop during the electroreduction process. The morphology of the 3D-cathode is shown in FIGS. 5E and 5F, which are described in more detail below. The deposited samples of thin-film CuS cathodes on the perforated silicon substrate were dried under vacuum at 100° C. for 24 h. XPS and EDS tests showed that the deposit consists of approximately 66% of copper monosulfide and approximately 34% of copper disulfide. A commercially available Celgard 2400 has been chosen as a separator and LiPF₆:EC:DEC with addition of 2% wt. VC (vinylene carbonate) solution was used as an electrolyte.

The Li/CuS cells were cycled at room temperature using a series 2000 battery test system produced by Maccor, Inc., Tulsa Okla. The voltage cut-off was 1.9 to 2.45V, with a charge/discharge at a current density of 50-200 μA/cm². The cells provided 1.8-2.2 mAh/cm² capacity for more than 400 reversible cycles with a capacity fade of 0.09%/cycle. The Faradaic efficiency was close to 100%.

### Example 2

A semi-3DCMB battery was assembled generally as described in Example 1. A gold current collector was obtained by electroless deposition on perforated-silicon substrate for 1 hour, using a bath of HAuCl₄(0.0125M), Na₂S₂O₃ (0.1 M), Na₂SO₃ (0.1 M), K₂HPO₄ (0.1 M), and Sodium ascorbate (0.1M). The pH of the bath was 6.5 and temperature was 60° C.

The copper sulfide composite cathodes were obtained by electrodeposition from the bath modified by PEGDME500 additive of 3:1 polymer- to copper-salt ratio. The concentrations of CuNa₂EDTA (formed in this case using Na₂EDTA and CuSO₄), elemental sulfur and ammonium buffer solution were similar to those described in Example 1 and in step 154. The concentration of PEGDME500 additive was 60 mM. The cathodic electrodeposition was carried out for 100 minutes at a constant current of 5 mA/cm². The pH of the electrolytic bath was 8-9 and the temperature was about 85° C. The cell was tested at a high pulse current density for two different pulse durations. The first pulse duration was 1 second followed by 20 second rest. At a 3:1 polymer-to-salt ratio, the semi-3DCMB cell was able to provide a peak power of 125 mW/cm² at almost 90 mA/cm² of battery footprint 1. In the second case, the pulse duration was 100 ms followed by 1 second rest. The semi-3DCMB cell was able to provide a peak power of 157 mW/cm² at 160 mA/cm2 of battery footprint.

### Example 3

A semi-3DCMB battery was assembled generally as described above in Examples 1 and 2. The deposition was carried out for 40 minutes at a constant current of 5 mA/cm². The semi-3DCMB provided 1 mAh/cm² reversible capacity at a discharge current of 100 μA/cm². This cell was subjected to various constant discharge current tests. After 13 cycles, the current density was enhanced to 200, 500 and 750 μA/cm² for about 6 cycles at each current consecutively. Subsequently, the cell was cycled at its initial discharge current (100 μA/cm²) and retained 90% of its initial capacity.

Further discharging of the cell at 1 mA/cm² for 5 cycles resulted in a capacity of 0.7 mAh/cm², while cycling of the cell at 3 mA/cm2 gave a capacity of 0.5 mAh/cm². Even after cycling at 5 mA/cm², the cell retained more than 80% of its initial capacity when cycled consecutively, for cycles where all of the battery capacity is discharged in 10 hours.

### Example 4

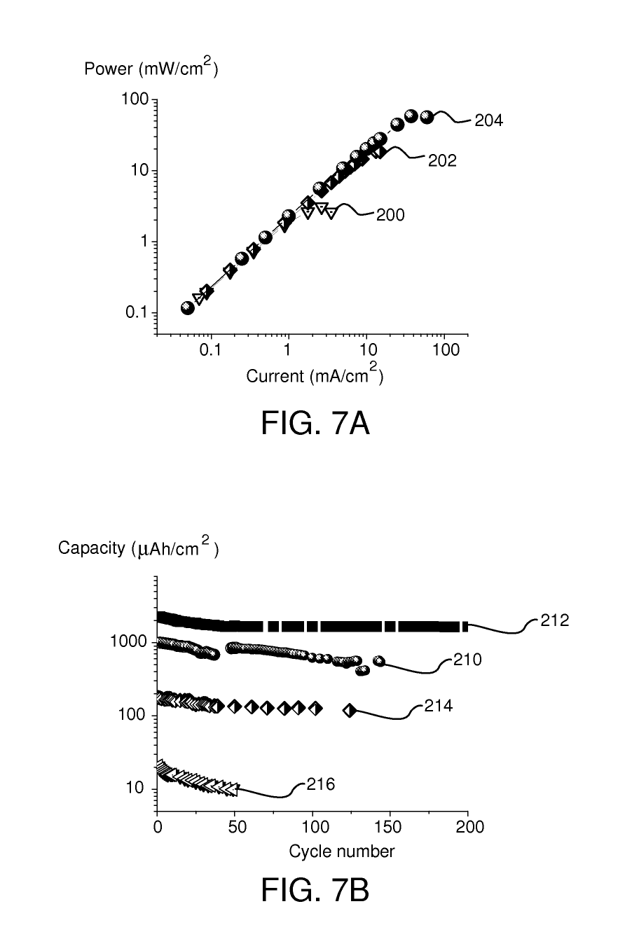

A semi-3DCMB battery was assembled generally as described in Examples 1 and 2. PEG2000 was added to the electrolyte. The CuS composite cathode was deposited from the electrolyte with 1:6 polymer-to-salt ratio at a current density of 5 mA/cm² for 1 hour on a Au-coated Si substrate. The reversible discharge capacity at 125 μAh/cm² of the semi-3DCMB battery approaches 1.8 mAh/cm². The 3D-modified nanostructured CuS electrodes on the perforated silicon substrate were able to provide almost 40 mA/cm² current and 60 mW/cm² peak power of battery footprint (as shown in FIG. 7A, described below) at a pulse duration of 10 second followed by a 5 minute rest period.

### Example 5

A semi-3DCMB battery was assembled generally as described in the Examples 1 and 2. However, the membrane was inserted by spin coating inside the microchannels of perforated substrate coated by a current collector and a cathode. A commercially available PVdF-2801 copolymer (Kynar) has been chosen for the hybrid polymer electrolyte. SiO₂ (Aerosil 130) was added to the polymer matrix to enhance the ionic conductivity and electrolyte uptake. Slurry was made out of these components. The PVdF powder is dissolved in high-purity cyclopentanone (Aldrich) or DMSO (dimethylsulfoxide). Fumed silica 130 (Degussa) and propylene carbonate (PC, Merck) are added, and the mixture is stirred at room temperature for about 24 hours to get a homogeneous slurry. Alternatively, the PEGDME can be used as a pore former. The thickness of the membrane and its morphology depended on the percent of solids in the casting slurry, and the type of solvent and pore former. A few sequential spin-coating and vacuum pulling steps were employed to insert the membrane slurry into the microchannels. The cell ran over 10 reversible cycles with capacity loss less than 0.1%/cycle.

As described above with reference to the flow charts of FIG. 3 and FIG. 4, modified copper sulfide cathodes of embodiments of the present invention are produced by electro-deposition from a bath containing CuNa₂EDTA, elemental sulfur, and a polymer. The inventors believe that the formation of the copper sulfide proceeds according to the reaction:

Cu(EDTA)²⁻+xS⁰+2e⁻→CuSₓ+EDTA⁴⁻ (1)

Equation (1) illustrates that the EDTA complex is reduced, and the inventors believe that the consequent formation of the copper sulfide is influenced by the slow mass transfer of the elemental sulfur.

To characterize unmodified copper sulfide cathodes, the reaction of equation (1) has been performed on planar substrates. The inventors have found that the morphology and the stoichiometry of the deposited unmodified copper sulfide films is a function of the stirring rate, the sulfur concentration, the pH, the temperature, and the deposition current or voltage. For example, under rapid stirring, bluish-black films, like those of CuS, are obtained. When solutions are slowly stirred or not stirred, brown films enriched in copper (Cu₂S) are deposited. The inventors have found that preparing unmodified copper sulfide cathodes by increasing the deposition time and current density results in peeling of the film and inability to deposit thick cathodes. (This may be caused by high internal stresses that develop during deposition.) As described below, modified copper sulfide cathodes do not suffer from these problems.

FIGS. 5A, 5B, and 5C are scanning electron microscope (SEM) images of deposited copper sulfide films formed on planar substrates, according to an embodiment of the present invention. A JSM-6300 scanning microscope produced by Jeol Ltd., Tokyo, Japan, and equipped with a Link elemental analyzer (also produced by Jeol Ltd.) and a silicon detector, was used to generate the images. The films were formed generally according to steps 100-108 of the flow chart of FIG. 3, the pH of the electrolyte being approximately 8.5, and the current density being approximately 1-2.5 mA/cm².

The images are of films that were formed by electrolysis for 30 min, 40 min, and 45 min respectively. The electrolyte was modified by adding polymer PEGDME500 0.12 M to the bath. The inventors have found that the modification not only influences the morphology, as described below, but enables the preparation of thick cathode films at a deposition rate up to ten times that found for a pristine cathode, without any adverse effects on the films. The cathode layers obtained with the modified electrolyte adhere strongly to the substrate. In contrast, as stated above, unmodified electrolytes under similar conditions result in films that peel from their substrate, as well as preventing the production of thick films.

As can be seen from the SEM images, the PEGDME-modified cathode films on planar substrates are predominantly constituted of plate-like and octahedral-shaped grains. The grains, in turn, are assemblages of small, closely-packed crystallites of about 35 nm size, as found by X-ray diffraction measurements. The longer the deposition process, the larger the grain size, with many grains reaching 5 μm. Increasing the acidity from pH 8.5 to pH 6.0 and the current density from 1 to 5 mA/cm² results in the formation of fine-grained structure, with grains having sizes less than one micron.

FIGS. 5D, 5E, and 5F are SEM images of deposited copper sulfide films formed on perforated substrates, according to an embodiment of the present invention. The films were formed using a modified electrolyte, generally according to steps 152 and 154 of the flow chart of FIG. 4, on a gold-coated perforated silicon chip, as described above for Example 1. The images were generated as described above for FIGS. 5A, 5B, and 5C, and are cross-sectional micrographs of the perforating channels. FIG. 5D shows an overall view of the channels; FIG. 5E shows the top of the channels; and FIG. 5F shows the middle of the channels. The images show that the morphology of the films deposited inside the channels is similar to that obtained on the planar substrates. However, the size of the grains does not exceed 0.8 μm.

The films referred to above with respect to FIGS. 5A-5F were analyzed using X-ray photoelectron spectroscopy (XPS) and energy dispersive spectroscopy (EDS). The analysis used a 5600 Multi-Technique System, produced by Physical Electronics, Inc., Chanhassen, Minn., and the measurements were performed at an ultra-high vacuum of approximately 2.5·10⁻¹⁰ Torr. The films were irradiated with an Al K_{α}, monochromated source (1486.6 eV) and the emitted electrons were analyzed by a Spherical Capacitor Analyzer with a slit aperture of 0.8 mm.

The spectra for the films gave three well-resolved doublets which correspond to CuS (covellite), Cu₂S (chalcocite) and non-stoichiometric sulfur-rich copper sulfide. Analysis of the spectra revealed that the cathode material formed using the modified electrolyte has 65.6% high-sulfur-content compounds, i.e., CuS and sulfur-rich copper sulfide. However sulfur-poor chalcocite (36.9%) is the dominating component of the high-deposition-rate samples, and these also have the most oxidized surface (25.7% CuSOₓ, x>1). Increasing the deposition time restores the original covellite content of the films and decreases the surface oxidation (8.2% CuSOₓ).

As is illustrated in FIGS. 5A-5F, the modified copper sulfide cathodes have grains that are of nanoscale dimensions.

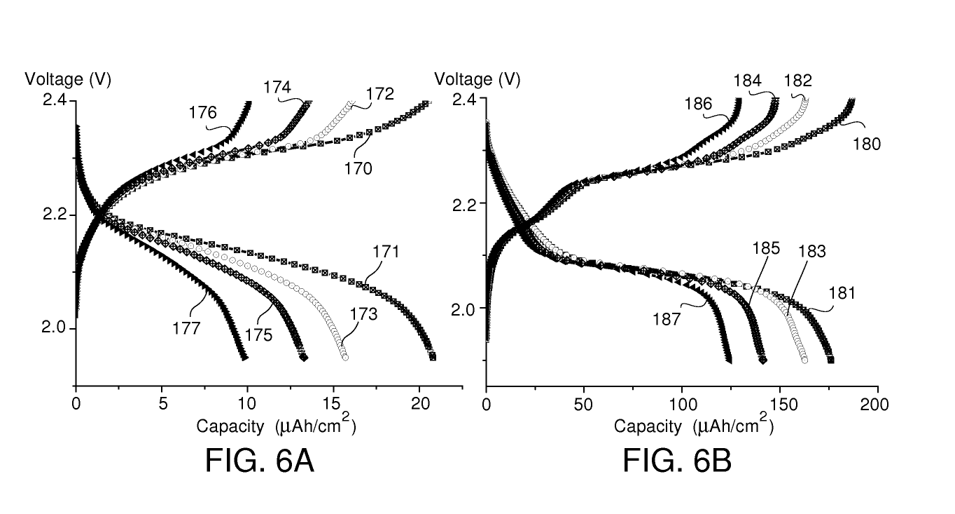

FIG. 6A and FIG. 6B show schematic charge/discharge graphs of planar Li/CuS cells, according to an embodiment of the present invention. FIG. 6A is for a cell where the copper sulfide cathode is pristine, i.e., is produced without the addition of polymer to the electrolytic bath. FIG. 6B is for a cell produced according to the flow chart of FIG. 3, i.e., with polymer added to the electrolytic bath. The graphs plot cell voltage (V) vs. cell capacity (μAh/cm²), and were generated using a series 2000 battery test system produced by Maccor, Inc.

FIG. 6A shows charge/discharge curves after 1, 10, 30, and 50 charge/discharge cycles. Graphs 170, 171 are after 1 cycle; graphs 172, 173 are after 10 cycles; graphs 174, 175 are after 30 cycles; and graphs 176, 177 are after 50 cycles. FIG. 6B shows charge/discharge curves after 1, 10, 30 and 100 cycles. Graphs 180, 181 are after 1 cycle; graphs 182, 183 are after 10 cycles; graphs 184, 185 are after 30 cycles; and graphs 186, 187 are after 100 cycles. In each cycle the discharge was terminated when the cell voltage reached approximately 1.9V. As is apparent from the graphs, the cells with a modified cathode (FIG. 6B) have a plateau, i.e., a region where the slope is approximately 0, at approximately 2.1 V, and this plateau is maintained for 100 cycles. In contrast, the cells with an unmodified (pristine) cathode have a non-zero slope even for the first cycle, and the slope steepens for increasing numbers of cycles.

In addition to the differences in slopes, it is apparent from the graphs that the cell with the modified cathode has a capacity that is of the order of ten or more times that of the cell with the pristine cathode. Thus, for cycle 50, at the end of its discharge the pristine cathode cell has a capacity of approximately 10 μAh/cm², whereas for cycle 100, the modified cathode cell has a capacity of approximately 125 μAh/cm² at the end of its discharge.

FIG. 7A shows schematic graphs illustrating the polarization properties of Li/CuS cells with unmodified and PEG2000 modified cathodes, according to an embodiment of the present invention. The polarization tests for the graphs were conducted at room temperature. Measurements on the cells were carried out by applying an ascending-step current for 10 seconds over the range of 18 μA/cm²-60 mA/cm². The cells were allowed to rest for one minute between steps.

The graphs plot specific peak pulse power (mW/cm²) vs. specific current (mA/cm²) for three different cells. Graph 200 is for a pristine planar cell; graph 202 is for a planar cell with a modified cathode produced with PEG500; and graph 204 is for a semi-3DCMB cell with a modified cathode produced with PEG2000. The graphs (graph 200) show that an unmodified planar cell has a peak pulse power of approximately 3.1 mW/cm², whereas a modified planar cell (graph 202) has a peak pulse power of approximately 18.5 mW/cm². The graphs also show that a semi-3DCMB cell (graph 204) is able to provide a current greater than 60 mA/cm² without any loss of peak power, which is approximately 55 mW/cm².

FIG. 7B shows schematic graphs illustrating the reversible capacity of Li/CuS cells with unmodified and modified cathodes, according to an embodiment of the present invention. The graphs plot reversible capacity (μAh/cm²) vs. number of cycles, and show that the reversible capacity of planar cells with modified cathodes is approximately six times the capacity of cells with unmodified cathodes. The graphs further show that this property continues for more than 120 cycles. Graphs 214 and 216 are respectively for planar modified and unmodified cathodes.

Graph 210 is for a semi-3DCMB cell with a PEG500 modified cathode, deposited for 50 minutes, and was generated using discharge rates varying from groups of 120 μA/cm² to groups of 3 mA/cm². There was a 10 minute rest between measurements, except for a 20 minute rest after the last 3 mA/cm² measurement. In addition to demonstrating increased capacity compared with both types of planar cells, the graph shows that the semi-3DCMB cell retains approximately 30% of its capacity when the discharge rate increases from 120 μA/cm² to 3 mA/cm².

Graph 212 is for a semi-3DCMB cell with a PEG500-modified cathode deposited for 100 minutes, and was generated using an initial discharge rate of 200 μA/cm2 followed by a discharge rate of 50 μA/cm2. The graph shows that the cell was cycled for about 400 cycles with excellent capacity retention, having 0.09% capacity loss per cycle.

The embodiments described above refer to modified copper sulfide cathodes, i.e., nanoscale copper sulfide cathodes that have been produced by addition of a polymer to the electrolytic bath used to form the cathodes. The inventors have found that the principles of production of such cathodes, as described above, may be applied to the production of modified cathodes of other materials. For example, a similar process to that of FIG. 3 or FIG. 4, but using an iron sulfide, FeₓS, where 0.5<x<1.1, may be applied to produce a modified iron sulfide cathode. In addition, a process similar to that of FIG. 3 or FIG. 4 may be used to form other metal sulfide cathodes, such as sulfides of nickel, cobalt, tungsten, vanadium, or manganese, which have been modified by incorporating polymer into the electrolytic bath.

The processes of FIG. 3 and FIG. 4 use electro-reduction for the production of modified cathodes. However, embodiments of the present invention are not limited to one particular type of electro-deposition for the production of modified cathodes. For example, the processes of FIG. 3 and FIG. 4 may be modified to comprise electro-oxidation, electropainting, or electrophoretic deposition with polymer containing solutions. (As is known in the art, electropainting is the process of the formation of a solid film on a cathode or an anode caused by a strong change of the pH near the electrode. As is also known in the art, in electrophoretic deposition charged powder particles, dispersed or suspended in a liquid medium, are attracted and deposited onto a conductive substrate of opposite charge on application of a DC electric field.) Such modifications enable the production of other types of nanoscale cathodes.

Furthermore, embodiments of the present invention are not limited to sulfides as the material that is modified to produce the nanoscale cathodes. For example, modified metal oxide cathodes, or modified metal oxysulfide cathodes, may also be produced by embodiments of the present invention. The metal oxysulfides are represented herein as MOₓS_{y}, where 0<x<3, 0<y<3, and M represents a metal selected from the group of metals Fe, Ni, Co, Cu, W, V, and Mn. As specific examples, the description below explains in more detail the production and properties of modified vanadium pentoxide cathodes, and modified FeOₓ S_{y} cathodes.

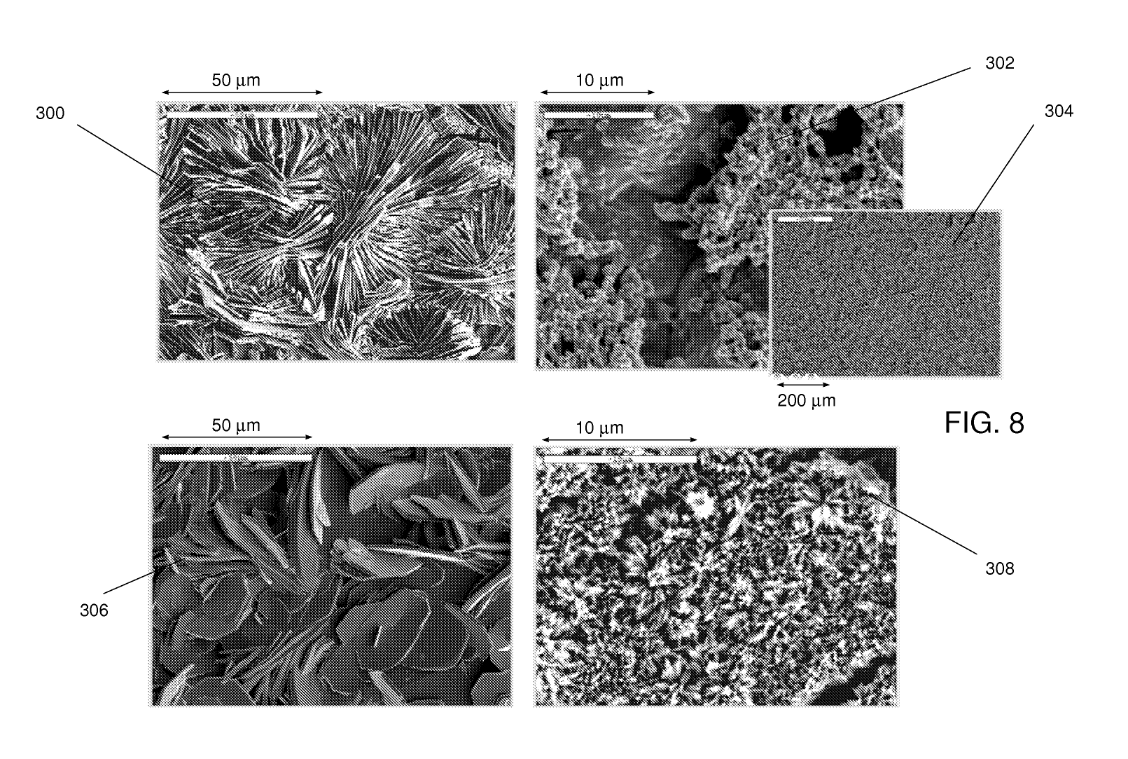

FIG. 8 shows SEM images of vanadium pentoxide, V₂O₅, cathodes, according to an embodiment of the present invention. The images of FIG. 8 are for cathodes of a planar cell. Diagrams 300, 302, and 304 show images of pristine V₂O₅ cathodes. The pristine cathode imaged in diagram 300 is produced by electrolysis of NH₄VO₃; the pristine cathode of diagrams 302 and 304 is produced by electrolysis of VOSO₄.

Modified V₂O₅ cathodes were produced generally according to the processes of FIG. 3 and FIG. 4, using polyaniline (PANI) as the polymer rather than the polymers described above with reference to FIG. 3.

Diagrams 306 and 308 are images of modified V₂O₅ cathodes respectively using a low polymer concentration and a high polymer concentration in the electrolytic bath. As is apparent from diagram 308, the modified cathodes have nanoscale dimensions.

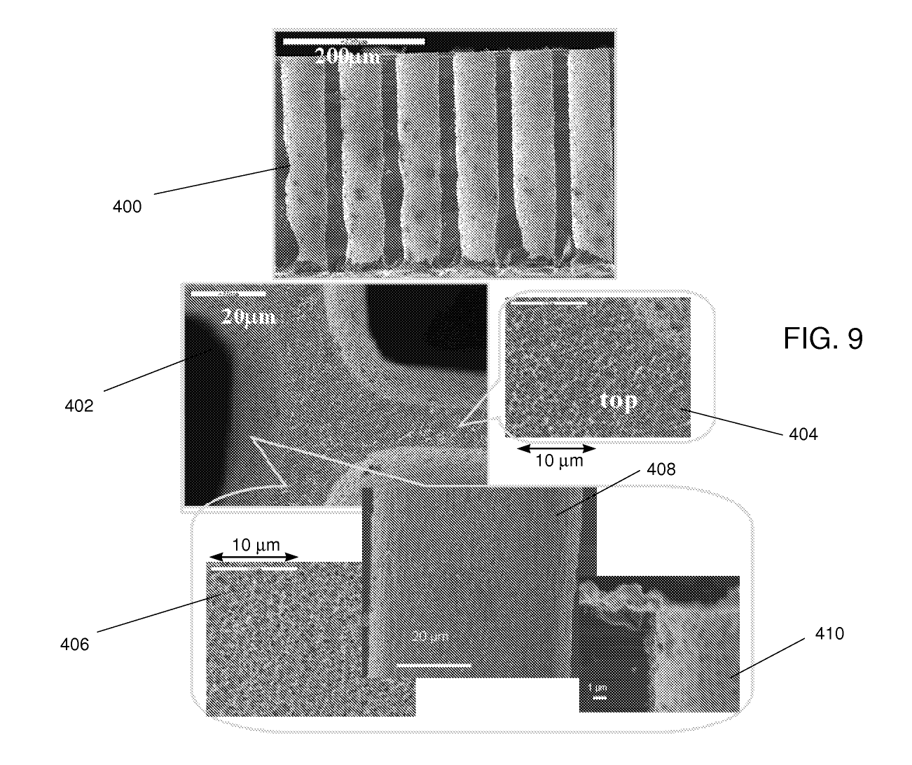

FIG. 9 shows SEM images of modified V₂O₅ cathodes, according to an embodiment of the present invention. The images of FIG. 9 are for cathodes of a semi-3DCMB cell. The modified cathodes were produced by electrolysis of 0.1M NH₄VO₃ at pH 7.0 and at a temperature 50° C. with a deposition current density of 3 mA/cm². Diagram 400 is a cross-section of the complete channels, diagrams 402 and 404 are images of the top of the channels, and diagrams 406, 408, and 410 are images of the middle of the channels. The diagrams illustrate that the modified V₂O₅, cathodes have nanoscale dimensions.

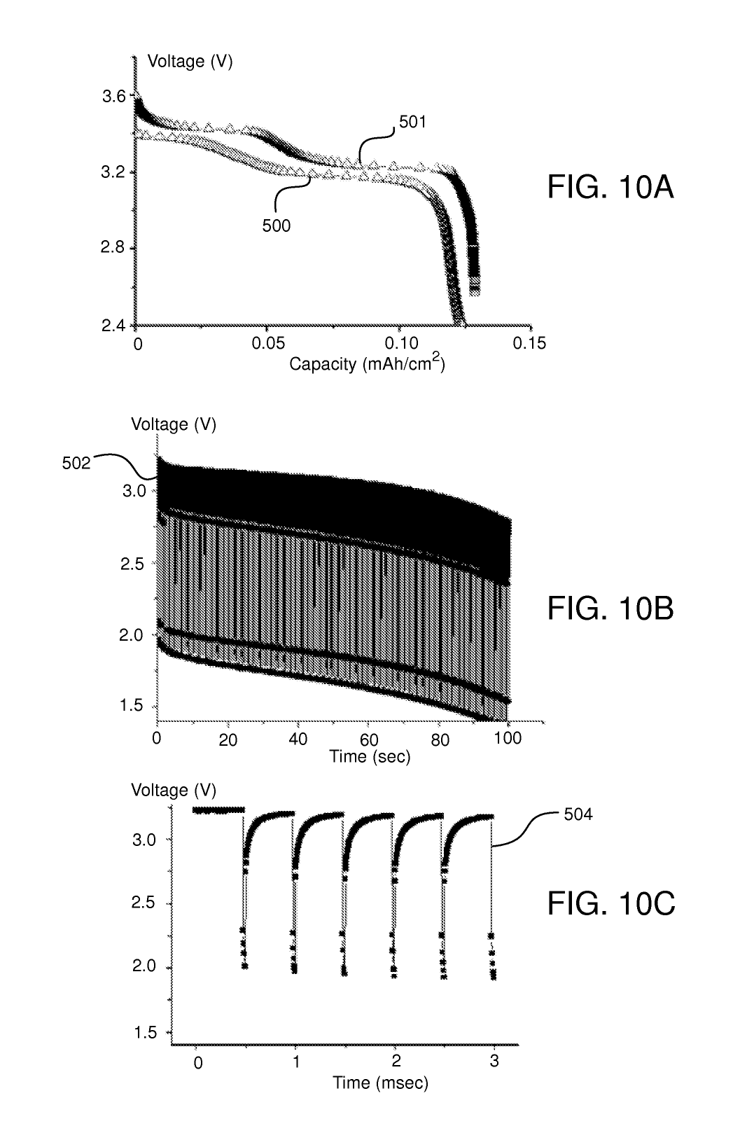

FIGS. 10A, 10B, and 10C show exemplary schematic graphs for cells with modified V₂O₅ cathodes, according to an embodiment of the present invention. Except where otherwise stated, the graphs are for modified V₂O₅ cathodes produced using the high polymer concentration stated above, and formed in a planar V₂O₅/Li cell.

In FIG. 10A a graph 500 plots the voltage (V) vs. the specific capacity (mAh/cm²) for the planar cell. The graph shows the discharge of the cell after it has been cycled through 40 charge/discharge cycles, and illustrates that there is a substantially zero slope region at approximately 3.2 V. A graph 501 is the corresponding charge plot of the cell. The graphs show low overvoltage between the charge/discharge processes, indicating low polarization, concentration and ohmic resistance of the cell.

In FIGS. 10B and 10C graphs 502 and 504 illustrate the good polarization properties of the cell. Graph 504 is a magnified view of the initial portion of graph 502. To produce the graphs the cell was configured to deliver 200 pulses with a current density of 28 mA/cm². The pulses delivered current for 25 μs, and there was a quiescent period of 475 μs between pulses, so that the overall period of pulse repetition was 0.5 ms. Graph 504 shows the pulses generated in the first 3 milliseconds, graph 502 shows the pulses for 100 s. As is illustrated by graph 502, there is virtually no polarization of the cell, so that the cell has very good power pulse capability.

The following examples illustrate several possible microbattery implementations having V₂O₅ cathodes that use methods disclosed herein.

Examples 6 and 7 are for planar microbatteries, Example 8 is for a semi-3DCMB.

### Example 6

A V₂O₅ cathode was electrodeposited on a Ni substrate from an electrolytic bath containing 0.1M NH₄VO₃ at an anodic current of 1-5 mA/cm². A crystalline deposit was achieved after thermal treatment for 5-6 hours at 350° C. In order to reduce the desired particle size, a high current density was applied during the first part of the deposition (10 mA/cm² for 30 min). The deposition process was continued at a low current density of 1 mA/cm² for 60 min. The morphology of the deposits is shown in diagram 308 of FIG. 8. The cell demonstrated a reversible capacity of about 0.2 mAh/cm² with a capacity degradation of about 0.13%/cycle.

### Example 7

A V₂O₅ cathode was electrodeposited from an electrolytic bath containing 0.1M VOSO₄ on a Ni substrate. After 15 min of deposition at 5 mA/cm² a V₂O₅ cathode with an amorphous structure was obtained. The Li/V₂O₅ cell exhibits reversible capacity of ˜60 μAh/cm².

### Example 8

A semi-3DCMB was assembled generally as described in the Examples 1 and 2. However a V₂O₅ cathode was deposited instead of CuS. The 3D-V₂O₅ cathode on the 3D-perforated Si substrate was obtained from an electrolytic bath containing 0.1M VOSO₄. A crystalline deposit was achieved after thermal treatment for 5-6 hours at 400° C. Using a semi-3D configuration of a Li/V₂O₅ cell accomplishes an increase of the discharge capacity by 3.5 times as compared to the planar cell of the same footprint area and a decrease of the charge/discharge overpotential.

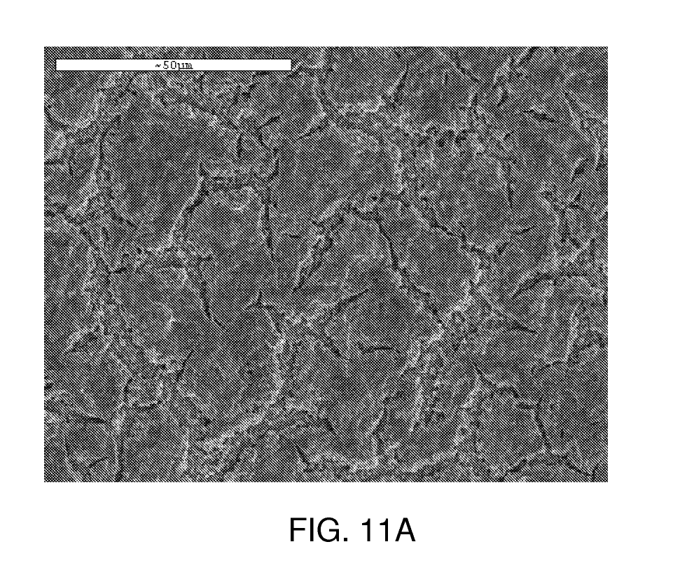

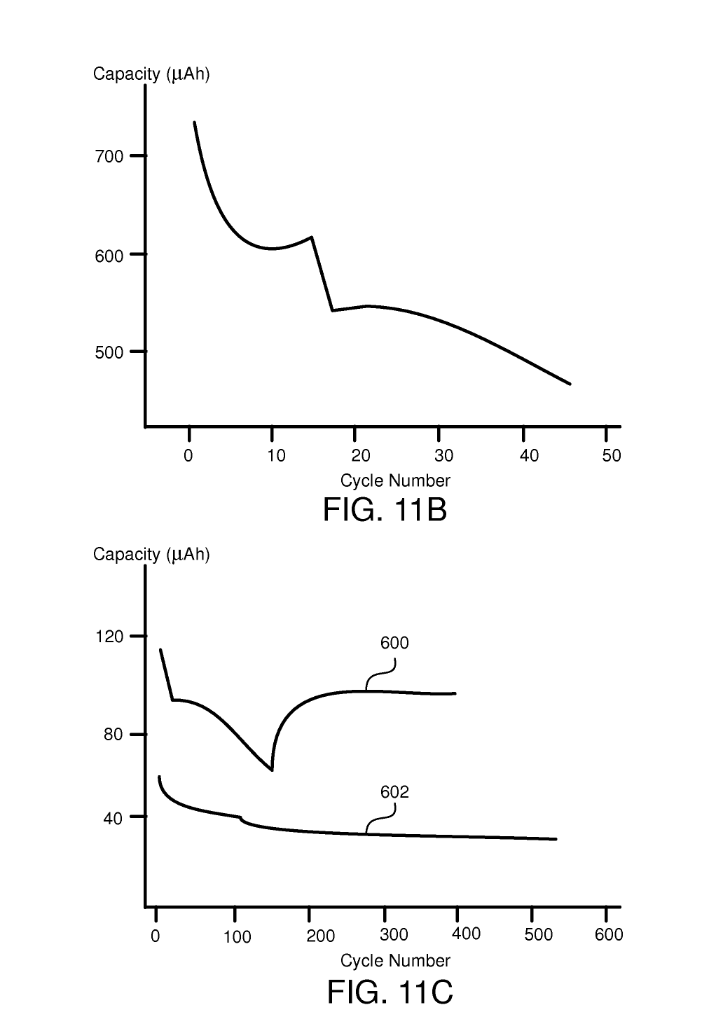

FIG. 11A shows an SEM image of a modified FeOₓS_{y} cathode, and FIGS. 11B and 11C show measurements on cells using the cathodes, according to embodiments of the present invention. Modified FeOₓS_{y} cathodes were produced generally according to the processes of FIG. 3 and FIG. 4. The electrolytic bath used to form the cathodes comprised a solution of FeCl₃ with Na₂S₂O₃, together with the polymer. The ratio of FeCl₃ to polymer was approximately 1:5.

FIG. 11A is an image of a modified FeOₓS_{y} cathode produced with an electro-deposition current density of 5 mA/cm². The figure illustrates that the modified cathode has nanoscale characteristics.

FIGS. 11B and 11C are schematic graphs showing change in cell capacity as a cell sequences through a set of charge/discharge cycles. FIG. 11B is for a pristine FeOₓS_{y} cathode; FIG. 11C is for modified FeOₓS_{y} cathodes. A graph 600 shows the change in cell capacity for a modified cathode produced at 5 mA/cm²; a graph 602 shows the change in cell capacity for a modified cathode produced at 10 mA/cm². The graphs illustrate that over 400 or more charge/discharge cycles the cell capacity is virtually unchanged.

The following examples illustrate several possible modified FeOₓ S_{y} cathodes, and properties of associated planar microbatteries, that use methods disclosed herein.

### Example 9

FeOₓ S_{y} modified cathodes were obtained by electrodeposition from a bath that contained 0.04M FeCl₃, 0.08M sodium citrate and 0.4M of thiosulfate on Ni substrates. The bath was modified by the addition of 0.04 to 0.08M of PEO or PEGDME500 as a binder. The inventors have found that modification by polymers causes smooth, homogenous morphology of cathodes with nano-size particles, and that the addition of polymers allows deposition at a wide range of currents from 3 to 15 mA/cm². Characterization of the cathodes in a Li/SPE/FeOₓS_{y} (SPE: solid polymer electrolyte) planar cell at 120° C. shows a fourfold increase of capacity from 0.2 mAh/cm² to 0.8 mAh/cm² when the cathodes were deposited for 1 hour.

### Example 10

FeOₓ S_{y} modified cathodes were obtained by electrodeposition from a bath containing 0.04M FeCl₃, 0.08M sodium citrate and 0.4M sodium thiosulfate on Ni substrates. The bath was modified by addition of 0.1 M of PEI as a binder. The smooth, dense and homogenous morphology of the cathode with submicron particles can be seen in FIG. 11A.

For electrochemical characterization, Li cells with these cathodes were assembled with a liquid electrolyte 1M LiPF₆ 1:1 EC/DEC. These cells shows excellent stability with capacity fade of only 0.01%/cycle. Even after discharging at high currents, the capacity of the cells returned to the previous value. The cells remained in their charge state after 4 month without cycling.

### Example 11

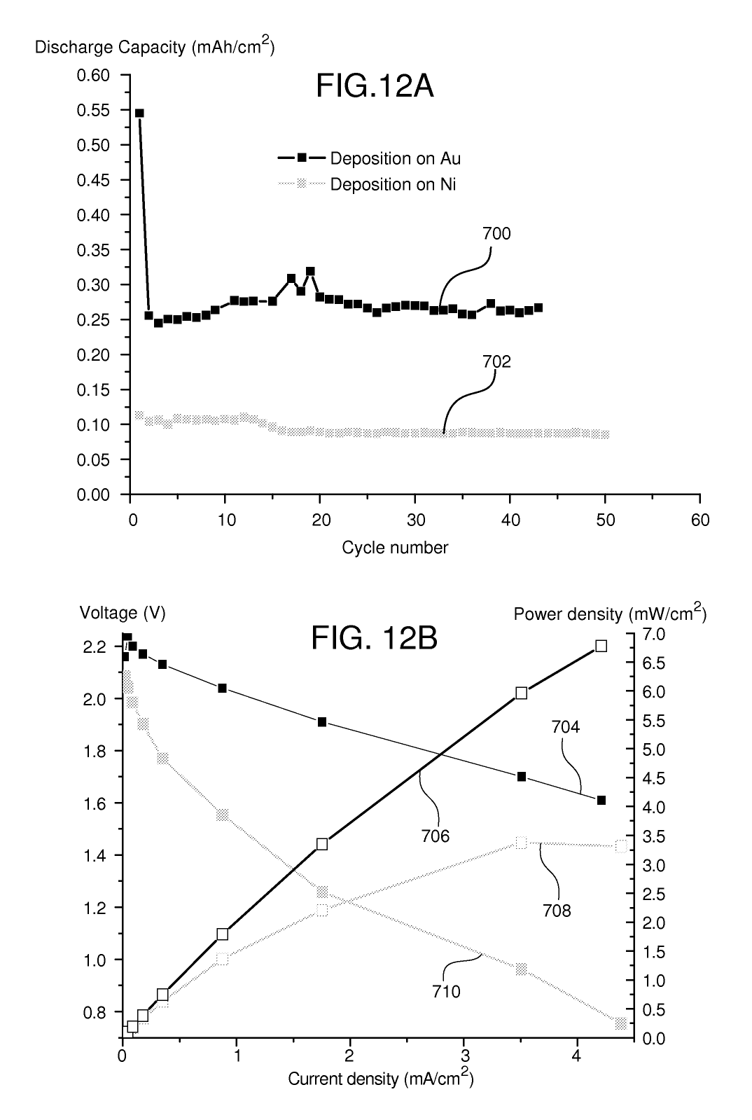

FIGS. 12A and 12B are schematic graphs of properties of FeOₓ S_{y} modified cathodes, according to an embodiment of the present invention. Graphs 700, 706, and 708 are for cathodes deposited on a gold substrate; graphs 702, 704, and 710 are for cathodes deposited on a nickel substrate. The FeOₓ S_{y} modified cathodes were deposited from the same bath as in Example 3. As is illustrated by the graphs, changing the substrate from Ni to Au caused an increase of discharge capacity by 2.5 times from 0.1 mAh/cm² to 0.27 mAh/cm² and a doubling of the peak power. The open circuit voltage of the cell still remains at 2.1V without significant decrease.

### Example 12

FeOₓ S_{y} modified cathodes were obtained by electrodeposition from a bath containing 0.04M FeCl₃, 0.08M sodium citrate and 0.4M sodium thiosulfate on Au substrates. The bath was modified by addition of 0.08M of PEO as a binder. The discharge capacity of the cells increased by a factor of 6 compared with a cell containing the modified cathodes deposited on Ni.

The inventors have used an electrophoretic deposition (EPD) method for the first time to prepare thin LiFePO₄ cathodes. The preparation was generally according to the steps describing cathode preparation, mutatis mutandis, of the flowcharts of FIG. 3 and FIG. 4. 3D-Lithiated cathodes, such as lithium iron (cobalt, nickel, tungsten) phosphate, lithium manganese oxide (LiMnO), lithium cobalt oxide (LiCoO) (doped by Al, Ni, etc) can be prepared by EPD as well. This method is particularly useful for coating of substrates having complex shapes, such as perforated, or interlaced silicon, for 3D-microbatteries application. Direct deposition of lithiated cathodes simplifies the fabrication of 3D-microbatteries, as a non-lithiated anode can be used in the battery. Lithiated cathodes, in addition, are high-voltage and respectively, high-energy and high-power materials.

The following examples illustrate several possible planar and semi-3DCMB implementations having LiFePO₄ cathodes that use methods disclosed herein.

### Example 13

A planar thin-film battery was assembled with a LiFePO₄ cathode prepared by electrophoretic deposition (EPD). LiFePO₄ powder (Hydro Quebec, Canada), black-pearl carbon (BP) and polyvinyldiene fluoride (PVdF) were dispersed in an acetone solution with 0.28 mg/L I₂. The weight percentage ratio of LiFePO₄:BP:PVdF was (91:4:5%). In one case, 0.4% v/v polymer triton-X 100 (TTX, (C₁₄H₂₂O(C₂H₄O)n)) was added to the dispersion. Black-pearl carbon and PVdF were used as conducting and binding materials, respectively. The modification of the film with TTX caused smoother and more homogeneous deposition during the EPD process. The addition of iodine produces charged particles in the solution through chemical reaction of I₂ with acetone. A nickel disk was used as a substrate (working electrode) and a graphite plate was used as a counter electrode. The constant voltage applied between the two electrodes was set at 60V for 60 seconds. The mass of the deposit was 9 mg after the EPD process. Pristine LiFePO₄ cathodes (without additives causing the cathodes to be modified) were also deposited by the same method for comparative study.

The electrochemical performance of the modified LiFePO₄ electrode was investigated by using discharge and charge cycle tests. Lithium metal was used as an anode and the electrolyte and separator was similar to that used in example 1. The cathode samples were vacuum-dried at 100° C. for 24 hours prior to assembly of the cells. Cycling and polarization tests were executed using a Maccor series 2000 battery test system.

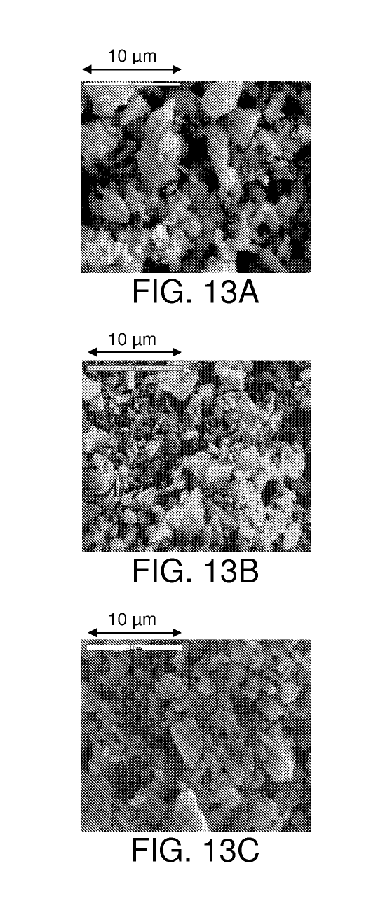

FIGS. 13A, 13B, and 13C are SEM images of LiPO₄, according to an embodiment of the present invention. FIGS. 13B, 13C show scanning electron micrographs of the LiFePO₄ electrodes prepared by the EPD process. FIG. 13A shows the LiFePO₄ powder used as received. FIGS. 13B and 13C display the pristine and modified LiFePO₄ deposited cathodes, respectively. As can be seen, the deposition of large LiFePO₄ particles was eliminated during the EPD process. The deposited LiFePO₄ particle size varied between 1-6 μm. The modification of the cathode film caused smoother and more homogeneous deposition during the EPD process.

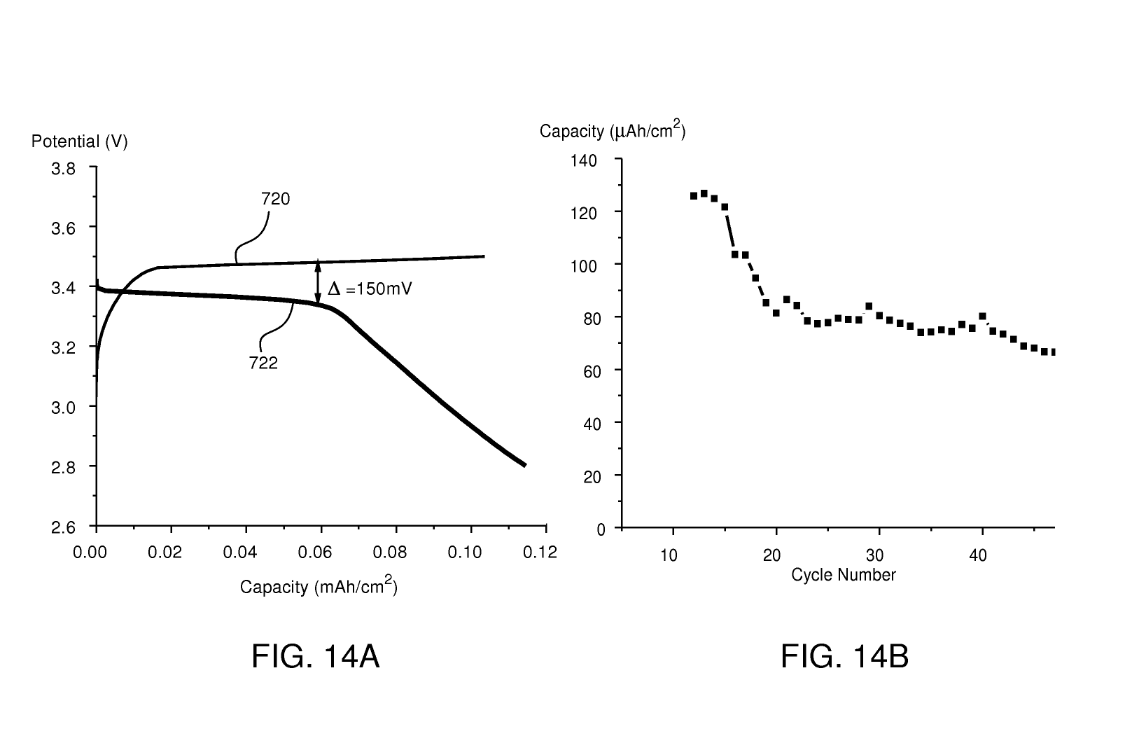

FIGS. 14A and 14B are schematic graphs of properties of cells with pristine LiFePO₄ cathodes, according to an embodiment of the present invention. FIG. 14A displays the voltage profile as a function of discharge, graph 702, and charge capacities, graph 700, of the 15th cycle. The cell was discharged/charged at a current of 80 μA/cm² of battery footprint, while the cutoff voltage was 2.8-3.5V vs. Li. The cell was allowed to rest for 5 minutes between each step. FIG. 14B represents the cycle life of the pristine Li/LiFePO₄ cell showing the charge capacity of the cell; the discharge capacity is substantially the same. After 50 consecutive cycles, the capacity faded by more than 50%, while the capacity loss was 1.1% per cycle.

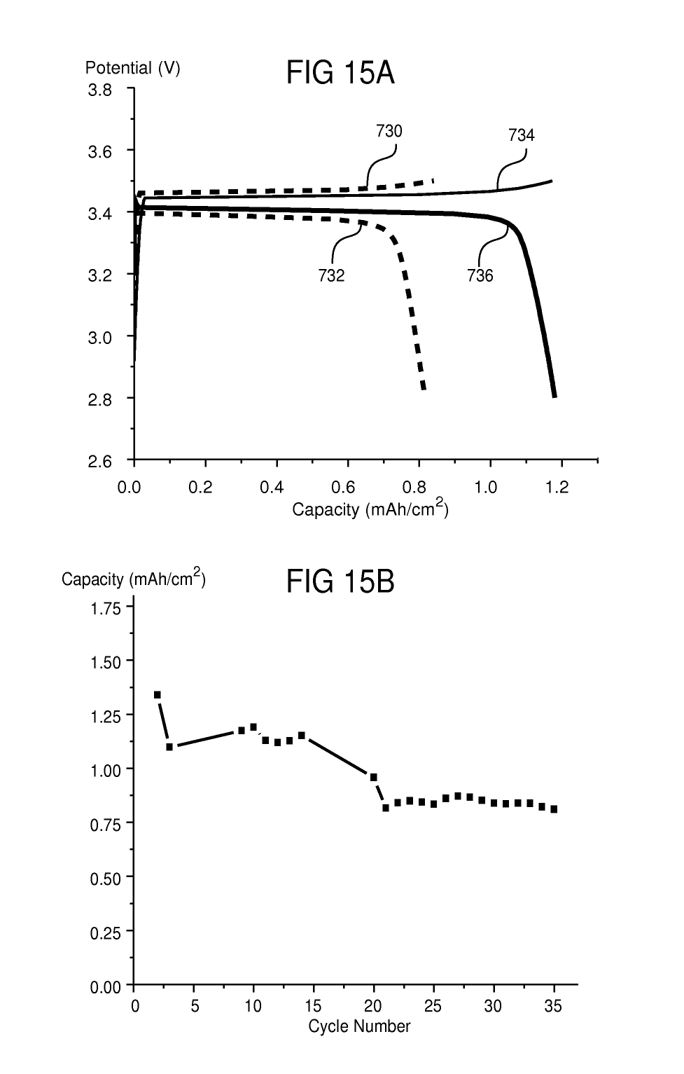

FIGS. 15A and 15B are schematic graphs of properties of cells with modified LiFePO₄ cathodes, according to an embodiment of the present invention. In FIG. 15A graphs 730 and 732 are charge and discharge curves after 20 cycles, graphs 734 and 736 are charge and discharge curves after 8 cycles. FIG. 15B shows the charge capacity of the cells; the discharge capacity was substantially the same. As illustrated in FIG. 15B, modification of the suspension with PVdF binder, BP and TTX-100 increased the capacity capability and the capacity retention compared to that of the pristine cell (FIG. 14B). As can also be seen from the graphs, the charge/discharge overpotential decreased from 150 mV for the pristine cell (FIG. 14A), to ˜40 mV for the modified cell.

### Example 14

The cell in example 13 was tested with high-pulse current densities for two different pulse durations. The first pulse duration was 1 second followed by a 20 second rest. The 2D-planar cell was able to provide a peak power of 125 mW/cm² at almost 80 mA/cm² of battery footprint. In the second test, the pulse duration was 10 seconds followed by a 5 minute rest. The cell was able to provide a peak power of 65 mW/cm² at a current of 35 mA/cm² of battery footprint.

### Example 15

In one embodiment of the invention, 5% wt. Ni nano-particles were incorporated into the suspension. LiFePO₄ powder (Hydro Quebec, Canada), black-pearl carbon (BP) and polyvinyldiene fluoride (PVdF) were dispersed in an acetone solution with 0.28 mg/L I₂. The weight percentage ratio of LiFePO₄:BP:PVdF:Ni was (85:5:5:5%). In this case, 0.4% v/v triton-X 100 (TTX) was added to the dispersion. Black-pearl carbon and PVdF were used as conducting and binding materials, respectively. Nickel and copper disks were used as substrates (working electrode) and a graphite plate was used as a counter electrode. The constant voltage applied between the two electrodes was set at 60V for 30 seconds. The mass of the deposit was 6.4 mg after the EPD process.

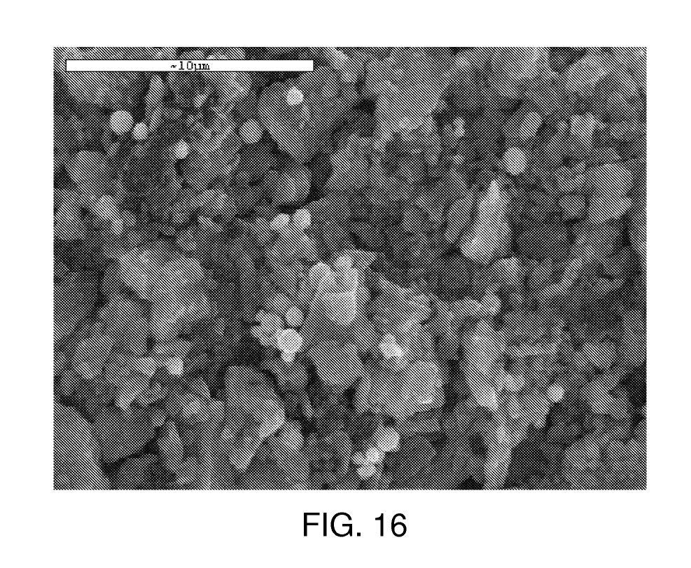

FIG. 16 shows a scanning electron micrograph of the Ni-incorporated LiFePO₄ electrodes prepared by the EPD process described above, according to an embodiment of the present invention. As can be seen, the larger LiFePO₄ grains were eliminated during the EPD process. The deposited LiFePO₄ particle size varied between 1-6 μm. The modification of the cathode film caused smoother and more homogeneous deposition during the EPD process.

The electrochemical performance of the Ni-modified LiFePO₄ electrode was investigated by using discharge and charge cycle tests as executed in example 13 and the cathode handling and cell assembly was also similar to example 13.

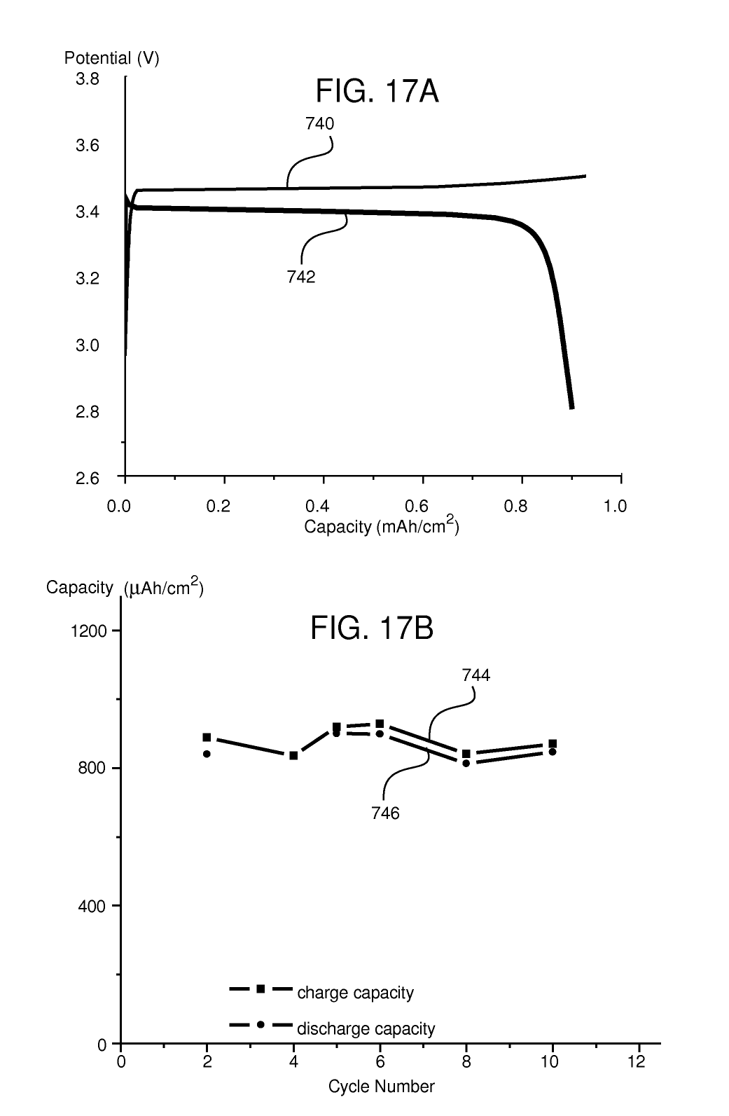

FIGS. 17A and 17B are schematic graphs of properties of a cell with the modified LiFePO₄ cathode, according to an embodiment of the present invention. FIG. 17A illustrates the potential vs. capacity for the fifth cycle of a charge/discharge test. Graph 740 is for the charge; graph 742 is for the discharge. FIG. 17B illustrates the capacity vs. the cycle number of the test. Graph 744 is the charge capacity, graph 746 is the discharge capacity. A maximum discharge capacity per mg of cathode deposited was obtained for the cell modified with Ni nano-particles (FIG. 17A). This cell delivered a capacity value of 900 μAh/cm², while its total mass after the EPD process was 6.4 mg, about 3 mg less than the modified cathode without addition of Ni-nano particles, that provided a capacity of 1200 μAh/cm² at the same cycling current density.

FIG. 17B shows the charge and discharge capacity as a function of cycles. After 10 consecutive cycles, the cell provided a value very close to its initial discharge capacity.

### Example 16

A planar thin-film battery was assembled with a LiFePO₄ cathode prepared by electrophoretic deposition as reported in example 13. LiFePO₄ powder (Hydro Quebec, Canada), black-pearl carbon (BP) and polyethylene imine (PEI) were dispersed in an acetone solution with 0.28 mg/L I₂. In one embodiment of the invention, 2% wt. polytetrafluoroethylene (PTFE) was incorporated in the acetone-based suspension described in example 13 instead of PVdF. The weight percentage ratio of LiFePO₄:BP:PEI was (87:4:9%). Black-pearl carbon and PEI were used as conducting and binding materials, respectively. The addition of iodine produces charged particles in the solution through chemical reaction of I₂ with acetone. A nickel disk was used as a substrate (working electrode) and a graphite plate was used as a counter electrode. The constant voltage applied between the two electrodes was set at 80V and the EPD duration was 50 seconds. The EPD process was repeated 3 times until the deposit mass increased to 4 mg. The electrochemical performance of the PEI-modified LiFePO₄ electrode was investigated by using discharge and charge cycle tests as executed in example and the cathode handling and cell assembly was also similar to example 13.

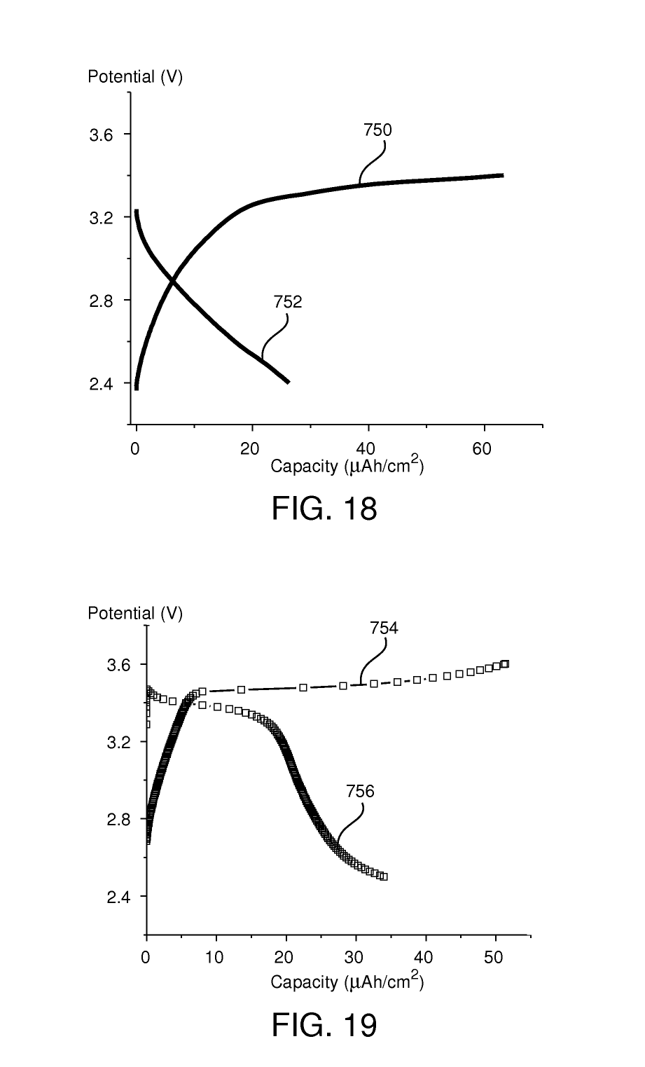

FIG. 18 displays a schematic voltage profile as a function of the discharge and charge capacities of the second cycle, according to an embodiment of the present invention. Graph 750 is for the charge, graph 752 is for the discharge. The cell was discharged/charged at a current of 20 μA/cm² of battery footprint, while the cutoff voltage was 2.4-3.3V vs. Li. The cell was allowed to rest for 5 minutes between each step. A large overpotential of 1V is noticed between the discharge and charge graphs. The discharge capacity value did not exceed 30 μA/cm², while the capacity obtained at charge was 30 μA/cm². The sloping character at discharge did not display a plateau as observed in the case of PVdF addition to the acetone-based suspension (FIG. 15A).

### Example 17

In one embodiment of the invention, 2% wt. polytetrafluoroethylene (PTFE) was incorporated in the acetone-based suspension described in example 13 instead of PVdF.

A planar thin-film battery was assembled with a LiFePO₄ cathode prepared by electrophoretic deposition as reported in Example 13. LiFePO₄ powder (Hydro Quebec, Canada), and shawinigan black carbon (SB) were dispersed in an acetone solution with 0.28 mg/L I₂. The weight percentage ratio of LiFePO₄:SB:PTFE was (94:4:2%). A nickel disk was used as a substrate (working electrode) and a graphite plate was used as a counter electrode. The constant voltage applied between the two electrodes was set at 80V and the EPD duration was 50 seconds. The EPD process was repeated 3 times. The electrochemical performance of the PTFE-modified LiFePO₄ electrode was investigated by using discharge and charge cycle tests as executed in example 13 and the cathode handling and cell assembly was also similar to example 13.

FIG. 19 displays a schematic voltage profile as a function of discharge and charge capacities of the 10th and 20th cycles, according to an embodiment of the present invention. Graph 754 is for the charge, graph 756 is for the discharge. The cell was discharged/charged at a current of 40 μA/cm² of battery footprint, while the cutoff voltage was 2.5-3.6V vs. Li. The cell was allowed to rest for 5 minutes between each step. A two-plateau discharge curve was noticed with a large overpotential. The discharge capacity value did not exceed 35 μA/cm², while the capacity obtained at charge was 50 μA/cm².

### Example 18

A semi-3DCMB was assembled as described in the Examples 1 and 2, however LiFePO₄ cathode was deposited instead of CuS.

The LiFePO₄ composite cathodes were obtained by electrophoretic deposition from the bath modified by carbon, PVdF and TTX.

The concentrations of LiFePO₄, BP carbon, PVdF and TTX were similar to those described in example 13. LiFePO₄ powder (Hydro Quebec, Canada), black-pearl carbon (BP) and polyvinyldiene fluoride (PVdF) were dispersed in an acetone solution with 0.28 mg/L I₂. The weight percentage ratio of LiFePO₄:BP:PVdF was (91:4:5%). In one case, 0.4% v/v triton-X 100 (TTX, (C₁₄H₂₂O(C₂H₄O)ₙ)) was added to the dispersion. The addition of iodine produces charged particles in the solution through chemical reaction of I₂ with acetone.

A gold current collector was formed by electroless deposition on a perforated-silicon substrate for 1 hour. The electroless bath contained: HAuCl₄(0.0125M), Na₂S₂O₃ (0.1M), Na₂SO₃ (0.1M), K₂HPO₄ (0.1M), Sodium ascorbate (0.1M). The pH of the bath was 6.5 and temperature was 60° C.

A special flow system was constructed in order to ensure conformal deposition inside the high aspect ratio channels. The Au-coated perforated sample was placed between two Pt grids acting as counter electrodes. The cell was connected to the reservoir of an electrolytic bath via a peristaltic pump that provided a constant flow rate of 0.15 L/min. A thin film LiFePO₄ layer was obtained by applying a negative constant potential to the Au-coated Si. The constant voltage applied between the two electrodes was set at 60V for 60 seconds. The mass of the deposit was 9 mg after the EPD process. Pristine cathodes (without additives) were also deposited by the same method for comparative study.

The semi-3DCMB was assembled as described in Example 1. The cell exhibited a reversible capacity of 3-4 mAh/cm² in good agreement with the geometrical area gain of the perforated Si substrate.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A method, comprising:
placing a substrate of a battery in a bath comprising a metal M chosen from a metal group consisting of Fe, Ni, Co, Cu, W, V, and Mn, an oxidant selected from an oxidant group consisting of oxygen and sulfur, and a polymer; and
applying an electrical current so as to form on the substrate a metal M compound cathode having a nanoscale grain structure.

2. The method according to claim 1, wherein the metal M comprises copper, wherein the oxidant comprises sulfur, and wherein the compound comprises copper sulfide.

3. The method according to claim 2, wherein the substrate has multiple channels therein, and wherein the copper sulfide cathode is deposited on an inner surface of the channels.

4. The method according to claim 3, wherein the multiple channels comprise multiple through channels perforating the substrate.

5. The method according to claim 2, wherein the copper is formed as ethylenediaminetetraacetic acid-disodium-copper (CuNa₂EDTA).

6. The method according to claim 2, wherein forming the copper sulfide cathode on the substrate comprises forming a metallic current collector on the substrate and depositing the copper sulfide cathode on the current collector.

7. The method according to claim 1, wherein the polymer is selected from a group of polymers consisting of polyethyleneimine (PEI), polyethylene glycol dimethyl ether (PEGDME), and polyethylene oxide.

8. The method according to claim 7, wherein a molecular weight of the PEGDME is selected from a group of weights consisting of 500 and 2000.

9. The method according to claim 1, wherein the metal M comprises vanadium, wherein the oxidant comprises oxygen, and wherein the compound comprises a vanadium oxide.

10. The method according to claim 9, wherein the polymer comprises polyaniline (PANI).

11. The method according to claim 9, wherein the vanadium is formed as one of a group of salts comprising NH₄VO₃ and VOSO₄.

12. The method according to claim 9, wherein the vanadium oxide comprises vanadium pentoxide (V₂O₅).

13. The method according to claim 1, wherein the oxidant comprises oxygen and sulfur, and wherein the compound comprises a metal oxysulfide.

14. The method according to claim 13, wherein the metal M comprises Fe, and wherein the bath comprises FeCl₃ with Na₂S₂O₃.

15. The method according to claim 14, wherein the ratio of FeCl₃ to polymer is 1:5.

16. The method according to claim 13, wherein the metal oxysulfide has a formula MOₓS_{y}, wherein 0<x<3, 0<y<3.

17. The method according to claim 1, wherein the metal M is selected from an element E chosen from a group of elements consisting of Fe, Ni, Co, W, V, and Mn;
wherein the oxidant comprises sulfur; and
wherein the compound comprises a sulfide of the element E.

18. A rechargeable microbattery comprising a copper sulfide cathode having a nanoscale grain structure.

19. A rechargeable microbattery comprising a vanadium oxide cathode having a nanoscale grain structure.

20. A rechargeable microbattery comprising a metal oxysulfide MOₓS_{y} cathode having a nanoscale grain structure, wherein a metal M of the metal oxysulfide is selected from a group of metals consisting of Fe, Ni, Co, Cu, W, V, and Mn, and wherein 0<x<3, 0<y<3.

21. A method, comprising:
placing a substrate of a battery in a bath containing lithium, phosphorus, oxygen, a metal M where M is selected from iron, nickel and cobalt, and a polymer; and
applying an electrical current so as to form on the substrate, by electrophoretic deposition (EPD), a lithium metal phosphate (LiMPO₄) cathode having a nanoscale grain structure.

22. A method, comprising:
placing a substrate of a battery in a bath containing lithium, a metal M where M is selected from manganese and cobalt, oxygen, and a polymer; and
applying an electrical current so as to form on the substrate, by electrophoretic deposition (EPD), a lithium metal oxide cathode having a nanoscale grain structure.

23. A battery comprising:
a substrate; and
a metal-M-compound electrode having a nanoscale grain structure and being formed on the substrate by applying an electrical current in a bath containing a metal M chosen from a metal group consisting of Fe, Ni, Co, Cu, W, V, and Mn, an oxidant selected from an oxidant group consisting of oxygen and sulfur, and a polymer.

24. A battery, comprising:
a substrate; and
a lithium metal phosphate (LiMPO₄) cathode having a nanoscale grain structure formed by electrophoretic deposition (EPD) on the substrate, wherein M comprises a metal selected from iron, nickel and cobalt.

25. The battery according to claim 24, wherein the substrate comprises a planar sheet.

26. The battery according to claim 25, wherein the planar sheet is non-perforated.

27. The battery according to claim 24, wherein the substrate comprises channels which perforate the substrate.

28. The battery according to claim 27, wherein the substrate comprises channels which partly pierce the substrate.

29. The battery according to claim 27, wherein the channels contain the LiMPO₄ cathode and an anode.

30. The battery according to claim 27, wherein the channels contain the LiMPO₄ cathode, the battery further comprising a planar anode not present in the channels.

31. The rechargeable microbattery according to claim 18, comprising a base whereon the copper sulfide cathode is formed, the base being chosen from a group consisting of a planar sheet substrate, a first perforated substrate having partially pierced channels, and a second perforated substrate having completely pierced channels.

32. The rechargeable microbattery according to claim 19, comprising a base whereon the vanadium oxide cathode is formed, the base being chosen from a group consisting of a planar sheet substrate, a first perforated substrate having partially pierced channels, and a second perforated substrate having completely pierced channels.

33. The rechargeable microbattery according to claim 20, comprising a base whereon the metal oxysulfide cathode is formed, the base being chosen from a group consisting of a planar sheet substrate, a first perforated substrate having partially pierced channels, and a second perforated substrate having completely pierced channels.
